(19) United States
(12) Patent Application Publication
(10) Pub. No.: US 2016/0187309 A1
(43) Pub. Date: Jun. 30, 2016

(54) POST-STEAM STERILIZATION MOISTURE-INDICATING METHODS AND ARTICLES

(71) Applicant: 3M INNOVATIVE PROPERTIES COMPANY, St. Paul, MN (US)

(72) Inventors: Myungchan KANG, Woodbury, MN (US); Evan Koon Lun Yuuji HAJIME, Woodbury, MN (US); Timothy J. NIES, Stillwater, MN (US); Erin A. SATTERWHITE, Chatham, NJ (US)

(21) Appl. No.: 14/442,475

(22) PCT Filed: Oct. 31, 2013
(86) PCT No.: PCT/US2013/067707

§ 371 Date: May 13, 2015

Related U.S. Application Data
(60) Provisional application No. 61/726,264, filed on Nov. 14, 2012.
(60) Provisional application No. 61/792,168, filed on Mar. 15, 2013.

(51) Int. Cl. G01N 31/22; B65B 55/10; G01N 21/78

(52) U.S. Cl. CPC G01N 31/222; G01N 21/78; B65B 55/10

(57) ABSTRACT

Methods for detecting moisture are described. The methods include sequential steps: (a) subjecting an article comprising a reversible moisture-indicating medium to steam sterilization in a steam sterilizer to produce a sterilized article; (b) subjecting the sterilized article to drying to reduce moisture in the sterilized article; (c) removing the sterilized article from the steam sterilizer; and (d) determining the level of moisture in the sterilized article after step (c) based on at least one property of the moisture-indicating medium. Packages comprising reversible steam-sterilization-compatible moisture-indicating media, including post-steam sterilization wet pack indicators, are also described

### FIELD

The present disclosure relates to methods and packages using reversible moisture indicators for detection of moisture following steam sterilization.

### BACKGROUND

Within the Central Sterilization (CS) Department of a hospital, medical instruments are cleaned, assembled, processed, packaged, stored, and issued for patient care. Medical instrumentation is received from the Operating Room into the decontamination area of the CS Department. There, instruments are manually washed and disinfected and visually assessed for cleanliness before placing in an automatic washer-disinfector. Once processed in a washer-disinfector, instruments are visually examined before packing and placement in a sterilizer. After sterilization, instruments are stored until needed in the Operating Room.

The time between sterilization and use may range from a few minutes to several weeks, thus the packaging materials and methods must allow for penetration of sterilant (i.e. saturated steam) during the sterilization process as well as protect the instruments from contamination during storage and handling. If the physical, microbial barrier provided by the sterilization packaging is compromised, the set of instruments is considered contaminated and must be reprocessed before use. Having to reprocess an instrument set can have undesired consequences, including decreased productivity in the CS Department and delayed surgeries. In an emergency situation, hospitals may use flash sterilization, a process which, though designed for the steam sterilization of patient care items for immediate use, may put patients at risk for increased surgical-site infections. Thus, reprocessing instruments is considered to be a major problem for Operating Rooms and CS Departments alike.

“Wet packs” are one reason packaged instrument sets may be deemed non-sterile and require reprocessing. An instrument set is considered wet when moisture in the form of dampness, droplets, or puddles of water is observed on or within a sterilization package such as a rigid container, non-woven wrap, peel pouch, or instrument after a completed steam sterilization cycle. Very simply, moisture can act as a vehicle to carry microorganisms inside the pack and contaminate the sterile instruments; making wet packs a significant problem in sterility assurance.

There are several potential causes for wet packs, including improper preparation/configuration of instrument sets, incorrect packaging materials or methods, improper loading of the sterilizer, insufficient drying time, improper cooling methods, poor steam quality, improperly drained steam supply lines, and/or improper cycle selection. Moisture on the outside of packs can usually be detected as soon as the packaged instruments are removed from the sterilizer. Internal pack moisture, however, can remain undetected until the packaged instrument sets are opened at the point of use. It is in this instance where latent internal moisture is discovered at the point of use in the Operating Room, where time and sterility assurance are most critical, that wet packs present the biggest problem.

### SUMMARY

The present disclosure is directed towards methods and packages for indicating moisture levels after steam sterilization. There is a need for a solution for providing an early indication of wet packs following steam sterilization.

In one aspect of the present disclosure, a method of detecting moisture is provided that includes the sequential steps of: (a) subjecting an article comprising a reversible moisture-indicating medium to steam sterilization in a steam sterilizer to produce a sterilized article; (b) subjecting the sterilized article to drying to reduce moisture in the sterilized article; (c) removing the sterilized article from the steam sterilizer; and (d) determining the level of moisture in the sterilized article after step (c) based on at least one property of the moisture-indicating medium.

In one embodiment of the method, the moisture indicating medium can comprise CoCl₂, CoBr₂, Co(SCN)₂, CuCl₂, CuBr₂, or combinations thereof. In another embodiment of the method, the moisture-indicating medium can comprise a solid metal oxide support and a bis(glyoxime)-transition metal complex bound to the support. In yet another embodiment of the method, the moisture-indicating medium can comprise a pH indicator dye. In another embodiment of the method, the article further comprises a post-steam sterilization wet pack indicator comprising a moisture-impermeable layer having a first surface, and a moisture-indicating layer comprising the moisture-indicating medium; wherein the moisture-indicating layer is disposed on or near the first surface of the moisture-impermeable layer; and wherein the moisture-indicating layer is dimensionally smaller than the moisture-impermeable layer, and the edges of the moisture-impermeable layer extend beyond the edges of the moisture-indicating layer.

In another aspect of the present disclosure, a package is provided that includes an enclosure defining a cavity; and a reversible steam-sterilization-compatible moisture-indicating medium in fluid communication with the cavity. At least a portion of the enclosure comprises a moisture-permeable material and allows permeation of steam into and out of the cavity.

In one embodiment of the package, the moisture indicating medium can comprise CoCl₂, CoBr₂, Co(SCN)₂, CuCl₂, CuBr₂, or combinations thereof. In another embodiment of the package, the moisture-indicating medium can comprise a solid metal oxide support and a bis(glyoxime)-transition metal complex bound to the support. In yet another embodiment of the package, the moisture-indicating medium can comprise a pH indicator dye.

The presented methods and packages can provide reversible and quantitative indications of the amount of moisture in sterilized packages following steam sterilization, including early indication of wet packs.

The above summary is not intended to describe each disclosed embodiment of every implementation of the present invention. The details of one or more embodiments of the invention are also set forth in the description below. Other features, objects, and advantages of the invention will be apparent from the description and from the claims.

### BRIEF DESCRIPTION OF THE DRAWINGS

FIG. 1 shows a perspective drawing of an exemplary embodiment of a package.

FIG. 2 shows a perspective drawing of an exemplary embodiment of a sterilization package.

FIG. 3 depicts a cross-sectional perspective of an exemplary embodiment of a process challenge device package.

FIG. 4A is a top view perspective of a wet pack indicator according to certain embodiments of the present disclosure.

FIG. 4B is a cross-sectional view of a wet pack indicator according to certain embodiments of the present disclosure.

FIG. 5 is a perspective view of an exemplary package according to certain embodiments of the present disclosure.

### DETAILED DESCRIPTION

In the following description, reference is made to the accompanying set of drawings that form a part of the description hereof and in which are shown by way of illustration several specific embodiments. It is to be understood that other embodiments are contemplated and may be made without departing from the scope or spirit of the present invention. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

As used herein:

“Bis(glyoxime)-transition metal complex” refers to a complex that has two glyoxime moieties complexed to a transition metal; as described further herein, the glyoxime moieties may have alkyl or other groups substituted for hydrogen at the ortho positions.

“Glyoxime” refers to vicinal dioximes of substituted or unsubstituted orthoketones.

“Hue” ranges in value from 0 to 360 (including all numbers in between), and refers to the degree to which a stimulus can be described as similar to or different from stimuli that are described as red, green, and blue and can be calculated using known mathematical techniques described further herein. “Humidity” and “moisture” are used interchangeably to include all forms of water, e.g. water vapor and liquid forms, present in an environment or adsorbed onto the surface of the moisture-indicating medium;

“Moisture-permeable,” “moisture-penetrable,” “steam-permeable,” and “steam-penetrable” are used interchangeably herein;

“Visible spectroscopic reflection color intensity change” refers to the difference observed between two color states and in some embodiments can be expressed as difference in Hue.

“Visible spectroscopic reflection” refers to measurements of reflections that are typically in the near UV-visible region of the electromagnetic spectrum—from about 350 nm to about 830 nm; it is understood that the actual reflection spectrum of a particular composition may be influenced by solvent, solvation, interference of thin surface coatings, and other environmental parameters such as temperature.

“Optical spectrum” refers to the spectrum of reflected and/or transmitted electromagnetic radiation in the near visible and visible wavelengths from and/or through an object. In some cases, the change in optical spectrum is a visible color change.

“Transition metal” refers to any element or elements having atomic numbers from 21-30, 39-48, 72-80, and 104-112. Exemplary transition metals include zirconium, titanium, rhodium, iridium, platinum, palladium, gold, nickel, copper, and combinations thereof.

Unless otherwise specified, as used herein, all relative humidity values refer to relative humidity as measured at room temperature (between 22° C. and 28° C.).

A variety of products and articles, including, for example, medical instruments, devices, bandages, and equipment, must be sterilized prior to use to prevent bio-contamination of a wound site, a sample, an organism, or the like. Typically, the items used in medical procedures are placed into a container and wrapped with a flexible wrap (e.g., a cloth or sheet) made of a gas-permeable material or the items are placed into a reusable vented rigid container. A number of sterilization processes are used that involve contacting the product or article with a sterilant. Examples of such sterilants include steam, ethylene oxide, hydrogen peroxide, and the like. Steam sterilization is widely used, at least in part because multiple batches of articles can be subjected to sterilization conditions during a 24 hour period using a single steam sterilizer. However, various conditions relating to the steam sterilization cycle or the packaging can result in the presence of moisture within the packs after sterilization, thereby compromising the sterility of the pack's contents. These so-called wet packs continue to be a problem in steam sterilization procedures.

There is a need in hospital CS Departments for a solution for providing an early indication of wet packs following steam sterilization. If identified early, wet packs may be reprocessed early so that only non-compromised sterile packs are transported to the Operating Room.

Some irreversible moisture indicators have been used to provide confirmation of the presence of steam during operation of steam sterilization autoclaves. However, once these moisture indicators have been subjected to the sterilization cycle, they are incapable of providing any information about the presence or absence of moisture after sterilization and drying. Furthermore, the elevated temperatures (often up to 135° C.) and pressures (often up to 2.8 bar) used in sterilization autoclaves may not be suitable for some moisture indicator materials, particularly colorimetric moisture indicators, and may prevent such indicators from performing as expected when once again subjected to lower temperatures and pressures following steam sterilization. Finally, many moisture indicators require complex detection equipment or may have a detection output that is difficult to detect.

It has been discovered that using reversible colorimetric moisture sensors that can withstand the temperatures and pressure of steam sterilization, that have a highly visible color across a wide range of humidity levels, and that can change qualitatively and/or quantitatively with a change in humidity can provide reliable indication of the amount of moisture present in sterilized packs following steam sterilization, and can therefore provide reliable early indication of wet packs.

The present disclosure generally provides methods for detecting moisture following steam sterilization. Generally, the method includes the sequential steps of: (a) subjecting an article comprising a reversible moisture-indicating medium to steam sterilization in a steam sterilizer to produce a sterilized article; (b) subjecting the sterilized article to drying to reduce moisture in the sterilized article; (c) removing the sterilized article from the steam sterilizer; and (d) determining the level of moisture in the sterilized article after step (c) based on at least one property of the moisture-indicating medium.

By reversible, it is meant that when the moisture-indicating medium is exposed to one set of humidity conditions, it has an original value associated with a specific property (such as a color, spectroscopic absorption, opacity, etc); then, when the set of humidity conditions is changed, the composition changes resulting in a different, second value associated with that specific property (for example, the composition changes color, opacity, etc.); and, finally, when the composition is returned to the initial set of humidity conditions, the composition changes again, resulting in a third value associated with that specific property. That resulting third value of the specific property returns to approximately the original value. In some embodiments, the moisture-indicating medium will exhibit complete reversibility. Such reversible moisture-indicating media substantially return to the original value of the specific property when re-exposed to the initial set of humidity conditions. Thus, for completely reversible moisture-indicating media, the third value of the specific property is substantially equivalent to the original value of the specific property. In other embodiments, the moisture-indicating medium will exhibit partial reversibility, i.e., when the composition is returned to the initial set of humidity conditions, the resulting third value of the specific property is closer to the original value than to the second value. In some embodiments, it is important that the changes in the specific property are easily detectable with the human eye (such as color or Hue changes, or opacity changes). In these embodiments, the human eye can detect the difference between the original value and the second value of the specific property, as well as the difference between the second value and the third value of the specific property. Thus, in some embodiments the difference between the original Hue number and the second Hue number, or the difference between the second Hue number and the third Hue number is in some embodiments at least 15, in some embodiments at least 30, and in some embodiments at least 60. In some color ranges, such as between Hue numbers of 0 and 60, or Hue numbers of 300 and 360, smaller differences in Hue are detectable. In other color ranges, such as between Hue numbers of 60 and 300, only larger differences in Hue number may be detectable. It is not necessary that the difference between the original value and the third value of the color (or Hue), if any, is detectable by the human eye.

In general, the sterilization process includes placing the moisture-indicating medium in a sterilizer. In some embodiments, the sterilizer includes a sterilization chamber that can be sized to accommodate a plurality of articles to be sterilized, and can be equipped with a means of evacuating air and/or other gases from the chamber and a means for adding steam to the chamber. The article comprising the moisture-indicating medium can be positioned in areas of the sterilizer that are most difficult to sterilize (e.g., above the drain in a steam sterilizer). Alternately, the article comprising the moisture-indicating medium can be positioned adjacent to (or in the general proximity of) an object to be sterilized when the article comprising the moisture-indicating medium is positioned in the sterilization chamber. In addition, the article comprising the moisture-indicating medium can be positioned in process challenge devices that can be used in sterilizers. In some embodiments, the article comprising the moisture-indicating medium can further contain objects to be sterilized, such as surgical instruments, medical devices, dental instruments, implants, dressings, and bandages.

The method further includes subjecting the article comprising the moisture-indicating medium to steam sterilization. The steam can be added to the sterilization chamber after evacuating the chamber of at least a portion of any air or other gas present in the chamber. Alternatively, steam can be added to the chamber without evacuating the chamber. A series of evacuation steps can be used to assure that the steam reaches all desired areas within the chamber and contacts all desired object(s) to be sterilized, including the article comprising the moisture-indicating medium.

The steam sterilization to which the article is exposed may be any of the steam sterilization processes according to conventional methods known in the art, including pre-vacuum and gravity steam sterilization processes. In at least some of the steam sterilization processes, an elevated temperature, for example, 121° C., 132° C., 134° C., 135° C., or the like, is included or may be encountered in the process. In addition, elevated pressures may be encountered, for example, 2.8 bar, or the like. Exemplary vacuum depths may include 0.8 bar, or the like. In some embodiments, steam exposure times can range from 3 minutes to 30 minutes, or the like, depending on the exposure temperatures. Exemplary drying conditions generally include post-vacuum depths of 100 mbar (1×10⁴ Pa) and other drying conditions according to conventional methods known in the art. In some embodiments, drying times can include 10 minutes, 20 minutes, 30 minutes, 40 minutes, 50 minutes, 60 minutes, or more.

Generally, once the sterilized article is removed from the steam sterilizer, the level of moisture in the sterilized article is determined by visually observing at least one property of the moisture-indicating medium. Other exemplary methods for determining the level of moisture in the sterilized article include observing the spectroscopic reflection or transmission of the moisture-indicating medium, or using other measurement methods such as colorimetry, reflectometry, digital imaging, and other conventional optical imaging methods.

In some embodiments exemplary properties of the moisture-indicating medium used in determining the level of moisture in the sterilized article after step (c) can include color, Hue, and opacity. In some embodiments, the at least one property of the moisture-indicating medium is directly related to the current level of moisture in the environment within which the moisture-indicating medium is located. For example, the color of the moisture-indicating medium may be directly related to the current level of moisture in the environment within which the moisture-indicating medium is located. The environment within which the moisture-indicating medium is located can be an area surrounding the moisture-indicating medium, including, for example, the sterilization chamber, a room, or a package. By directly related, it is meant that the property gives information about the level of moisture in the environment within which the moisture-indicating medium is located. This information may be approximate, or may be quantitatively related to the level of moisture in the environment within which the moisture-indicating medium is located. Where color is observed to determine the level of moisture, the moisture-indicating medium will, in some embodiments, exhibit a distinct color change with varying moisture conditions. For example, the moisture-indicating medium may exhibit two different colors at two different levels of relative humidity, such as appearing green at a relative humidity of 30% and appearing pink at a relative humidity of 70%. Color may be observed visually with the human eye, or with the assistance of measuring devices such as a spectrophotometer or a colorimeter. Hue may be quantitatively related to the level of moisture in the environment within which the moisture-indicating medium is located, and may be determined by converting a measured reflection spectrum to Hue using known mathematical techniques as described further herein. Thus, determining the level of moisture may include visually observing the color of the reversible moisture-indicating medium or measuring the visible reflection or transmission spectra of the moisture indicating medium. Moisture-indicating media that exhibit less distinct color changes may also be useful, particularly where measurement instruments are used to observe the color property of the moisture-indicating medium. Opacity may also be observed visually with the human eye, or with the assistance of measuring devices.

The method may further comprise the step of comparing the at least one property of the reversible moisture-indicating medium to a corresponding predetermined threshold to determine whether the sterilized article is adequately dry. By adequately dry, it is meant that the sterilized article is dry enough to be acceptable for its intended use and for the environmental conditions of its intended use. For example, adequately dry articles may be articles that are not considered to be wet enough to allow entrance of contaminants, such as microbes, into the article. Another example of an adequately dry article may include a predetermined level of moisture in the environment surrounding the article that corresponds to a reduced potential for condensation. By “corresponding predetermined threshold”, it is meant that the observed property of the moisture-indicating medium and the predetermined threshold will be of the same property type. For example, if the color of the moisture-indicating medium is observed, the corresponding predetermined threshold can include a certain color or a chart of colors that are indicative of certain levels of moisture at certain temperatures. The desired particular levels of moisture and temperature ranges for the predetermined threshold colors will be dependent upon the specific moisture-indicating medium used, as well as the desired application in which the method is being used, but can be determined by those skilled in the art. Exemplary corresponding predetermined thresholds may include a certain color, Hue, level of opacity, or other specific measurements of transparency or light intensity during absorption conventionally known in the art. In some embodiments, the predetermined thresholds are indicative of defined relative humidity values. In some embodiments, the level of moisture may correlate directly with the relative humidity of the environment. The predetermined thresholds may be determined by direct measurement, or may be generally known in the state of the art. In some embodiments, predetermined threshold colors may include green, yellow, orange, pink, blue, purple, and white. Predetermined threshold Hues will be dependent upon the specific moisture-indicating medium used, as well as the desired application in which the method is being used, but can be determined by those skilled in the art. For example, in some embodiments, predetermined threshold Hues for CoCl₂ indicators may include values from 180 to 240 and 280-360. Similarly, predetermined threshold opacity values can be dependent upon the specific moisture-indicating medium used, as well as the desired application in which the method is being used, but can be determined by those skilled in the art. Opacity can be measured using optical transmission or reflection methods, and can sometimes be expressed as a percentage. Generally, predetermined threshold values for all properties (e.g., color, Hue, opacity, etc.) will correlate with significant changes in the corresponding property, such as the level of environmental moisture at which a particular moisture-indicating medium expresses a distinct color change.

The article used in the method comprises the moisture-indicating medium. The article may further comprise a cavity defined by an enclosure. At least a portion of the enclosure comprises a moisture-permeable material that allows steam to penetrate into and out of the cavity. The moisture-indicating medium may be placed inside or outside of the cavity. In some embodiments, the enclosure may comprise a woven or non-woven wrap, a flexible container, a rigid container, a peel pouch, a polymeric matrix, paper, and combinations thereof. Additional exemplary articles used in the method include the packages described herein.

In some embodiments, the article further comprises a post-steam sterilization wet pack indicator comprising a moisture-impermeable layer having a first surface and a moisture-indicating layer comprising the moisture-indicating medium. In some embodiments of the wet pack indicator, the moisture-indicating layer is disposed on or near the first surface of the moisture-impermeable layer and the moisture-indicating layer is dimensionally smaller than the moisture-impermeable layer, such that the edges of the moisture-impermeable layer extend beyond the edges of the moisture-indicating layer. By disposed on or near, embodiments wherein the moisture-indicating layer is disposed directly upon the moisture-impermeable layer, and embodiments wherein there are one or more optional layers disposed between the moisture-impermeable layer and the moisture-indicating layer are included. By moisture-impermeable, it is meant that the moisture-impermeable layer is substantially moisture impermeable such that the majority of moisture reaching the moisture-indicating layer does not pass through or across the moisture-impermeable layer.

In other embodiments of the wet pack indicator, the moisture-impermeable layer comprises a recess and the moisture-indicating layer is disposed within the recess. In some embodiments of the article used in the method, at least a portion of the enclosure comprises a moisture-permeable material; the moisture-permeable material has an interior defining a portion of the cavity; the moisture-permeable material has an exterior; and the post-steam sterilization wet pack indicator is located on the exterior of the moisture-permeable material.

In some embodiments, the wet pack indicator used in the method may further comprise one or more optional middle layers disposed between the moisture-impermeable layer and the moisture-indicating layer. The optional middle layers may comprise color-enhancing layers, wicking layers and adhesives. In some embodiments, the wet pack indicator may further comprise one or more optional base layers. The optional base layers may comprise a moisture-permeable material, or the enclosure or a portion of the enclosure. In some embodiments, the wet pack indicator used in the method may further comprise one or more optional lower layers. The optional lower layers may be disposed on the surface of the moisture-indicating layer opposite the moisture-impermeable layer, and may be disposed between the moisture-indicating layer and the one or more optional base layers. The optional lower layers may comprise adhesives, color-enhancing layers, wicking layers, and challenge layers.

The optional middle layers and lower layers may have the same area size as the moisture-indicating layer, or may be bigger or smaller in dimensional area than the moisture-indicating layer. In some embodiments, the area of the optional middle and lower layers is dimensionally smaller than the moisture-impermeable layer, and the edges of the moisture-impermeable layer extend beyond the edges of the optional middle and lower layers. The optional base layers may have the same area size as the moisture-indicating layer or the moisture-impermeable layer, or may be bigger or smaller in dimensional area than the moisture-indicating layer or the moisture-impermeable layer.

In some embodiments, the moisture-impermeable layer is peripherally bonded to a base layer, e.g. the enclosure, such that the moisture-indicating layer is disposed between the moisture-impermeable layer and the base layer. By peripherally bonded it is meant that the edges of the moisture-impermeable layer are completely bonded to the base layer such that the moisture-indicating layer is completely enclosed between the moisture-impermeable layer and the base layer. It is intended that where the base layer is moisture-penetrable, moisture reaches the moisture-indicating layer predominantly through the moisture-penetrable base layer rather than through other paths.

In some embodiments of the wet pack indicator used in the methods and packages described herein, the moisture-indicating layer is directly attached to the moisture-impermeable layer. In some embodiments, one or more optional middle layers disposed between the moisture-indicating layer and the moisture-impermeable layer may comprise pressure-sensitive adhesive or heat-bondable adhesive to allow attachment of the moisture-indicating layer to the moisture-impermeable layer. In some embodiments, the moisture-indicating layer is extruded directly onto the moisture-impermeable layer. In some embodiments, the moisture-indicating layer and the moisture-impermeable layer are co-extruded.

In some embodiments, the wet pack indicator is attached to a base layer or to a portion of the enclosure comprising a moisture-permeable material. Attachment of the wet pack indicator to the base layer or moisture-permeable material is generally facilitated through bonding by the use of adhesives, extrusion processes, ultrasonic bonding, or other appropriate attachment mechanisms know in the art. The attachment method, particularly the adhesives, should be steam-sterilization compatible.

Suitable adhesives for use in the wet pack indicators, packages, and methods described herein may include pressure-sensitive adhesives, repositionable adhesives, heat-bondable adhesives, hot-melt adhesives, and other adhesives known in the art. Exemplary pressure-sensitive adhesives preferably include water-resistant pressure sensitive adhesive such as cross-linked acrylics, tackified rubber adhesives (e.g. natural rubber polyisoprene styrene butadiene rubber), and the like. Exemplary repositionable adhesives include those described in U.S. Pat. No. 6,905,763. Other exemplary adhesives include adhesives based on acrylic, urethane, and silicone polymers, polyurethanes, styrene block copolymers, polycarbonates, fluoropolymers, silicone rubbers, polyamides, polyesters, polyolefins, and ethyl-vinyl acetate copolymers. The adhesives are preferably able to withstand the temperatures, pressures, and moisture levels of steam sterilization processes. In some embodiments, the adhesives are moisture-permeable. In some embodiments, the adhesives are clear, transparent, or sheer. One skilled in the art can readily select adhesives appropriate for the desired use.

In some embodiments, the method may further include the step of placing the reversible moisture-indicating medium in fluid communication with the cavity prior to step (a) subjecting an article comprising a reversible moisture-indicating medium to steam sterilization in a steam sterilizer to produce a sterilized article. This can be accomplished, for instance, by placing the moisture-indicating medium directly into the cavity, or by connecting the moisture-indicating medium to the cavity by way of a path or tube that allows free exchange of fluids. Additionally, in some embodiments, the moisture-indicating medium can be placed on the exterior of an enclosure as long as it remains in fluid communication with the interior environment of the enclosure.

In another aspect, a package is provided that includes an enclosure defining a cavity; and a reversible steam-sterilization-compatible moisture-indicating medium in fluid communication with the cavity; and wherein at least a portion of the enclosure comprises a moisture-permeable material and allows permeation of steam into and out of the cavity. The moisture-indicating medium may be placed inside or outside of the cavity. By steam-sterilization-compatible moisture-indicating medium, it is meant that the moisture-indicating medium can be subjected to steam sterilization without significantly altering or damaging the moisture-indicating properties of the moisture-indicating medium.

In some embodiments, the package further comprises a post-steam sterilization wet pack indicator disposed upon the moisture-permeable material, wherein the post-steam sterilization wet pack indicator comprises a moisture-impermeable layer and a moisture-indicating layer comprising the moisture-indicating medium. The moisture-impermeable layer of the wet pack indicator is peripherally bonded to the moisture-permeable material such that the moisture-indicating layer is disposed between the moisture-permeable material and the moisture-impermeable layer. In some embodiments, the moisture-permeable material has an interior defining a portion of the cavity, and the moisture-permeable material has an exterior. The moisture-impermeable layer of the wet pack indicator is peripherally bonded to the exterior of the moisture-permeable material.

In some embodiments, the package enclosure may comprise a flexible or a rigid enclosure. Enclosure materials should be compatible with steam sterilization and maintain sterilization integrity during and after exposure to the steam sterilization process. In some embodiments, enclosure materials can comprise any material that is substantially permeable to steam and that has filtration properties sufficient to prevent the passage of pathogenic microorganisms through the enclosure. Exemplary rigid enclosures include materials such as metal, plastic, glass, ceramic, composites, a polymer, and combinations thereof. Exemplary flexible enclosures include materials made from metals, plastics, polymers, wraps, and combinations thereof. In some embodiments, the package contents, such as surgical instruments, may be contained in an interior container such as an instrument tray situated within the cavity of the enclosure.

In some embodiments, a substantial portion of the materials comprising the enclosure of the package are constructed of moisture-impermeable materials such as metal. In some such embodiments, a portion of the enclosure comprises a venting region comprising a plurality of openings. The venting region is equipped with a moisture-permeable filter to allow permeation of steam into and out of the cavity within the enclosure through the filter and the plurality of openings in the venting region. The filter may be integral to the container, or may be attached either on the exterior or interior of the container at the venting region by mechanical methods or by use of adhesives. In other embodiments, the entire rigid container is covered with a sterilization wrap rather than using filters. In some embodiments, the entire rigid package may be covered in openings and may use multiple filters, or may be wrapped with a sterilization wrap rather than using a filter.

A sterilization wrap or filter typically is permeable to a sterilant (e.g., steam), and the sterilization wrap typically maintains sterility of the enclosed articles after reprocessing by presenting a barrier to entry of microorganisms. Exemplary flexible wraps and filters are generally characterized as falling into two main classes, reusables and disposables. Reusables are materials which, as the name suggests, can be reused, typically by washing or by some other form of cleaning. Disposables, on the other hand, are usually one-use items that are discarded or recycled after their initial use. Generally, cloth, linen or other woven materials fall into the reusable category while disposables normally include non-woven materials made from either or both natural and synthetic fibers such as paper, medical grade paper, fibrous polymeric non-wovens as well as films that are capable of passing sterilants such as steam and retarding transmission of bacteria and other contaminants.

The non-woven materials can be made from a variety of processes including, but not limited to, air laying processes, wet laid processes, hydroentangling processes, spunbonding, meltblowing, staple fiber carding and bonding, and solution spinning. The fibers themselves can be made from a variety of both natural and synthetic materials including, but not limited to, cellulose, rayon, polyesters, polyolefins, polyamides, many other thermoplastic materials, a derivative of any of the foregoing materials, or a combination of any two or more of the foregoing materials.

The enclosure may also comprise combinations of flexible and rigid materials, such as a steel instrument tray wrapped in a non-woven wrap or a steel container with a venting region having a plurality of openings and a moisture-permeable filter covering the openings. Wrapping the articles (i.e. the moisture-indicating medium and/or the objects to be sterilized) can be done according to conventional methods known in the art.

In some embodiments, the package comprises a sterilization package. Sterilization packages may comprise an enclosure comprising a flexible sterilization wrap, a flexible container, or a rigid container. In some embodiments, the package or sterilization package may further comprise objects to be sterilized. The object to be sterilized can be any object that is appropriate to subject to a sterilization process. Non-limiting examples of suitable objects include surgical instruments, medical devices, dental instruments, implants, dressings, and bandages. In some embodiments, the objects to be sterilized may be placed inside the cavity of the package. In some embodiments, the objects to be sterilized may be placed inside an interior space within a sterilization package. In some embodiments, the package contents, such as surgical instruments, may be contained in an interior container such as an instrument tray situated within the cavity of the enclosure.

In some embodiments, the cavity is in fluid communication with the interior space of a sterilization package. In some embodiments, the moisture-indicating medium positioned within the cavity can be used to determine the amount of moisture within the interior space of a sterilization package through the fluid connection. In an exemplary configuration, the interior space of a sterilization package may comprise the cavity. Alternately, the interior space of a sterilization package may be connected to the cavity by way of a path or tube that allows free exchange of fluids.

Although reversible colorimetric moisture indicators can be placed inside sterilization packages and test packs to indicate the presence of moisture and wet pack conditions in the internal environment of a sterilization packages after steam sterilization, as described in U.S. Provisional Application No. 61/726,264 filed Nov. 14, 2012 [3M Docket No. 69692US003], in some embodiments, the moisture-indicating medium may be part of a wet pack indicator that can be placed on the exterior of a sterilization package rather than within the cavity, as described in U.S. Provisional application Ser. No. ______, filed on Mar. 15, 2013 [3M Docket No. 71446US002], incorporated herein in its entirety.

In some embodiments, the package can be a process challenge device or test pack that simulates moisture environments experienced by different types of sterilization packages, and the moisture-indicating medium can be placed within a process challenge device. In some embodiments, the process challenge device can comprise layers of challenge barriers positioned within the cavity and surrounding the moisture-indicating medium. The layers can all be constructed of the same material, or they can each be independently constructed of different materials.

Challenge layers may have varying degrees of fluid permeability and modifying the environment around the moisture-indicating layer and/or moisture-indicating medium (e.g. the challenge layers may make it more difficult to dry the moisture-indicating layer or medium and/or more difficult to wet the moisture-indicating layer or medium). Exemplary materials for challenge layers useful in the wet pack indicators and process challenge devices described herein include hydrophilic or hydrophobic materials, sponges, papers, wovens, and non-wovens. In some embodiments, hydrophilic or hydrophobic materials may be situated in close proximity to the moisture-indicating medium to create an environment around the indicator which is more or less humid at a given condition of humidity in the steam sterilizer chamber. Other exemplary methods for modifying the environment around the moisture-indicating medium to create a process challenge device include changing the degree of encapsulation (e.g., partial encapsulation of the moisture-indicating medium, thin layer of coating on the moisture-indicating medium, deeply embedding the moisture-indicating medium in matrix), changing the matrix properties of the encapsulant (e.g., hydrophobicity, porosity, etc.), changing the heat capacity of the surrounding materials near the moisture-indicating medium, and changing the gas diffusion path length toward the moisture-indicating medium (e.g., placing fibrous or porous materials between the steam or water vapor source and the moisture-indicating medium, placing a long, lumen device between the steam or water vapor source and the indicator material, etc.). Exemplary materials useful in modifying the environment around the moisture-indicating medium to create a process challenge device include hydrophobic materials, hydrophilic materials, sponges, papers, medical grade papers, wovens, non-wovens, cellulose, rayon, thermoplastic polymers, a derivative of any of the foregoing materials, or a combination of any two or more of the foregoing materials.

Wicking layers may be useful in modifying the color change behavior of the moisture-indicating layer of the wet pack indicators and/or the moisture-indicating medium of the methods and packages described herein with respect to the level of moisture within the enclosure, process challenge device, or sterilization package (e.g., the wicking layers may make it easier to wet the indicator and more difficult to dry the moisture-indicating layer). Wicking layers may contain materials that readily absorb moisture from the surroundings such as hygroscopic salts. Hygroscopy of salts generally refers to the ability of the salts to attract, absorb, hold, and transport moisture from the ambient or surrounding environment. The hygroscopic salts may be employed either singly or in a mixture in accordance with the invention. Thus, a wicking layer comprising hygroscopic salt may refer to a wicking layer made of a single hygroscopic salt or mixtures of more than one hygroscopic salt. In some embodiments, the wicking layer includes a hygroscopic salt comprising an anion selected from the group comprising halide, nitrate, acetate, carbonate, and hydroxide, and comprises a cation selected from the group comprising ammonium, an alkali metal, an alkaline earth metal, and a transition metal. Exemplary hygroscopic salts for use in the wicking layers described herein include lithium bromide, lithium chloride, magnesium chloride, magnesium nitrate, sodium chloride, sodium bromide, potassium acetate, zinc bromide, cesium fluoride, zinc chloride, sodium iodide, potassium fluoride, lithium iodide, calcium bromide, sodium hydroxide, potassium hydroxide.

In some embodiments of the indicators, packages, and articles used in the methods described herein, the wet pack indicator may include a color-enhancing layer. In some embodiments, optional middle layers, optional lower layers, and optional base layers may include color-enhancing layers. In some embodiments, the color-enhancing layers can have a color similar to the dry state of the moisture-indicating medium, wet state of the moisture-indicating medium, or another color. In some embodiments, the color-enhancing layer is white. The color-enhancing layers are located in close proximity to the moisture-indicating layer such that visual comparison between the moisture-indicating layer and the color-enhancing layer is readily accessible. For example, in some embodiments, the color-enhancing layer is disposed on top of the wet pack indicator (on the surface of the moisture-impermeable layer opposite the first surface of the moisture-impermeable layer upon which the moisture-indicating layer is disposed). In some embodiments, the color-enhancing layer is disposed between the moisture-impermeable layer and the moisture-indicating layer. In some embodiments, the color-enhancing layer is disposed on the surface of the moisture-indicating layer opposite the moisture-impermeable layer. In some embodiments, the color enhancing layer includes a hole or transparent portion that creates a viewing area through which the moisture-indicating layer remains visible. In some embodiments, the color-enhancing layer appears from the perspective of one observing the wet pack indicator (e.g. from the top of the indicator attached to a sterilization package, or from the bottom of the indicator after it has been peeled off a sterilization package) as a backing, at least a portion of which extends beyond the edges of the moisture-indicating layer such that both the moisture-indicating layer and the color-enhancing layer are visible. In some embodiments, the color-enhancing layer is a transparent or sheer layer comprising properties that make the color of the moisture-indicating layer appear more intense or clear to an observer. The role of the color-enhancing layer is to provide a clearer visual indication of color change between wet and dry states of the moisture-indicating media.

In some embodiments, the packages provided herein may further comprise a window or other transparent features for viewing the cavity, the moisture-indicating medium, the interior space of a sterilization package, or combinations thereof.

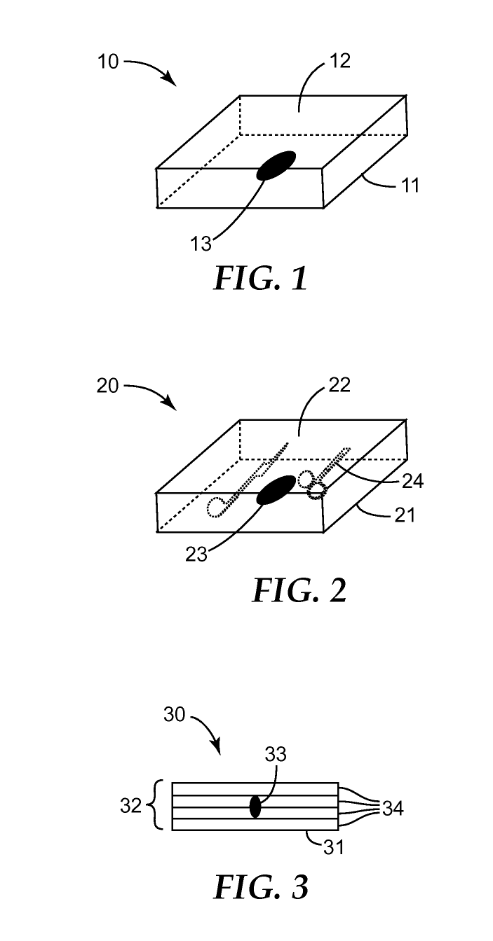

Turning to the drawings, FIG. 1 shows a perspective drawing of an exemplary embodiment of a package (10). An enclosure (11) defines a cavity (12) within which a moisture-indicating medium (13) is placed.

FIG. 2 shows a perspective drawing of an exemplary embodiment of a sterilization package (20). An enclosure (21) defines a cavity (22) within which a moisture-indicating medium (23) is placed. Objects to be sterilized (24), e.g. surgical instruments, are also placed within the cavity (22).

FIG. 3 depicts a cross-sectional perspective of an exemplary embodiment of a process challenge device package (30). An enclosure (31) defines a cavity (32) within which a moisture-indicating medium (33) is placed. Layers of challenge barriers (34) are positioned within the cavity (32) and surround the moisture-indicating medium (33). The layers (34) can all be constructed of the same material, or they can each be independently constructed of different materials.

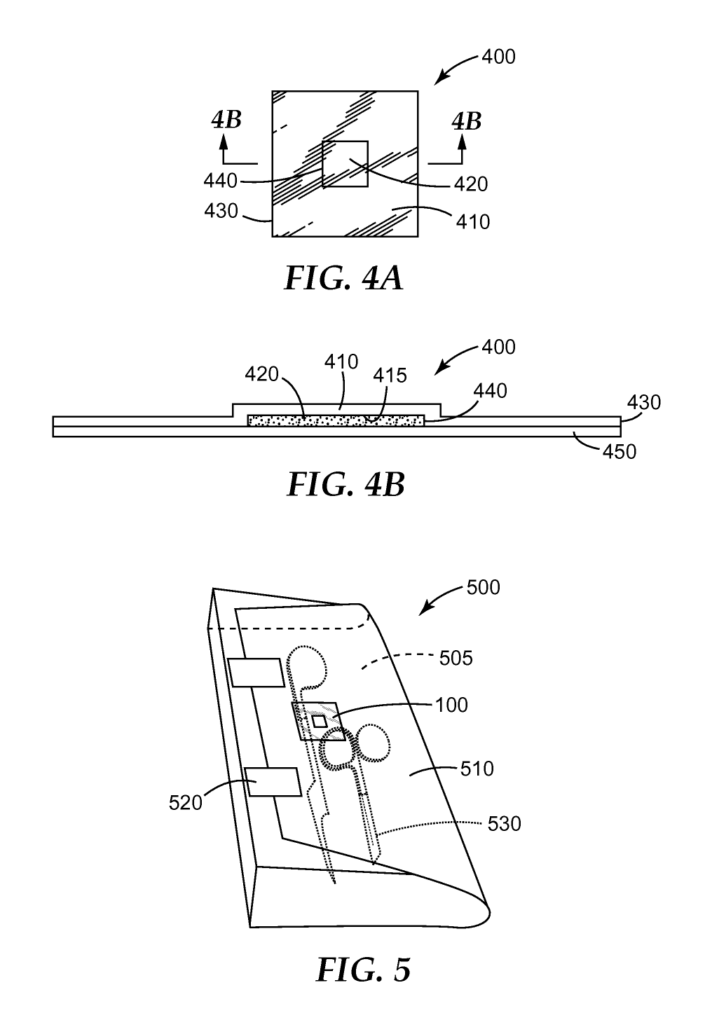

FIG. 4A depicts a top view perspective of one embodiment of a wet pack indicator 400 of the present disclosure. In some embodiments, the wet pack indicator 400 can be used on the exterior of a sterilization package. The wet pack indicator 400 comprises a moisture-impermeable layer 410 having a first surface, and a moisture-indicating layer 420 disposed upon the first surface of the moisture-impermeable layer 410. The area of the moisture-indicating layer 420 is dimensionally smaller than the area of the moisture-impermeable layer 410 such that the edges 430 of the moisture-impermeable layer extend beyond the edges 440 of the moisture-indicating layer. In some embodiments, the moisture-impermeable layer 410 may be transparent or sheer such that the color of the moisture-indicating layer 420 is visible through the moisture-impermeable layer 410. In some embodiments, the moisture-impermeable layer 410 may be non-transparent, opaque, or solid-colored such that the color of the moisture-indicating layer 420 is not visible through the moisture-impermeable layer 410. Where the moisture-impermeable layer is non-transparent, opaque, or solid-colored, the moisture-indicating layer of the wet pack indicator may be visually observed from the bottom side of the wet pack indicator (for example, after peeling the indicator off of the exterior of a sterilization package).

FIG. 4B depicts a cross-sectional view of a wet pack indicator 400 according to certain embodiments of the present disclosure. The wet pack indicator 400 comprises a moisture-impermeable layer 410 having a first surface 415, and a moisture-indicating layer 420 disposed upon the first surface 415 of the moisture-impermeable layer 410. The area of the moisture-indicating layer 420 is dimensionally smaller than the area of the moisture-impermeable layer 410 such that the edges 430 of the moisture-impermeable layer extend beyond the edges 440 of the moisture-indicating layer. The indicator may optionally include at least one base layer 450 comprising a release liner or other suitable material such as a non-wovens, wovens, color-enhancing layers, adhesives, challenge layers, and wicking layers. In some embodiments, the moisture-impermeable layer 410 is peripherally bonded to the base layer 450 such that the moisture indicating layer 420 is disposed between the base layer 450 and the moisture-impermeable layer 410.

FIG. 5 depicts a package 500 comprising a sterilization wrap enclosure 510. The package 500 comprises an enclosure (i.e. the wrap) 510 defining a cavity 505 and one or more wet pack indicators 100 as described herein disposed upon the exterior of the enclosure 510. The enclosure (i.e. the wrap) is held together by a fastener, such as adhesive strips (e.g. autoclave tape). Surgical instruments 530 are placed within the cavity 505 of the package for sterilization.

The moisture-indicating media used in the methods, articles, and packages provided generally include reversible, colorimetric moisture indicators. The moisture-indicating media may alternately include reversible moisture indicators that exhibit a change in opacity as surrounding humidity levels change. The moisture-indicating layer of the wet pack indicators described herein comprises moisture-indicating media. While any suitable steam-sterilization-compatible moisture-indicating medium can be used, some exemplary moisture-indicating media include bis(glyoxime) transition metal complexes bound to solid supports, as well as cobalt and copper salts, and pH indicator dyes.

In some embodiments, the color, reflection spectrum, or transmission spectrum of the moisture-indicating medium is quantitatively related to the level of moisture in the environment in which the moisture-indicating medium is located. In some embodiments, the moisture-indicating medium quantitatively changes color, reflection spectrum, or transmission spectrum at relative humidities ranging from about 0% to about 90% relative humidity. In some embodiments, the moisture-indicating medium quantitatively changes color, reflection spectrum, or transmission spectrum at relative humidities ranging from about 30% to about 80% relative humidity. In some embodiments, the moisture-indicating medium quantitatively changes color, reflection spectrum, or transmission spectrum at relative humidities of about 10% to about 90%.

The moisture-indicating medium can exist in different structural forms. In some embodiments, the moisture-indicating medium can be in articulated bulk shape, monolith, or particulate forms, such as beads, pellets, spheres, granules, extrudates, and tablets. In some embodiments, the moisture-indicating medium can be in film form, such as coatings and free-standing films. In some embodiments, the moisture-indicating medium can be in the form of fibers, such as yarn, rods, and needles. The moisture-indicating medium may also be present in the form of molecular species, such as metal complexes.

These various forms of the moisture-indicating medium can be used directly in the application. For example, a moisture-indicating medium film may be coated directly on the surgical instrument tray. Alternatively, the moisture-indicating medium forms may be made into a multimedia construction in combination with other media and/or containment devices.

Exemplary multimedia constructions can include loose-packed indicator constructions (e.g., particles or fibers contained in a vial, packed in a tube, or wrapped in a flexible fabric), loose, non-packed indicator constructions (e.g., physically entangled moisture-indicating media in a fibrous web, such as particle-loaded webs), multilayer constructions (e.g., indicator films on or between additional material layers which may have varying degrees of fluid permeability, or indicator particles or fibers sandwiched between containment layers), partially embedded or encapsulated constructions (e.g., particles or fibers partially embedded in a polymer, such as an adhesive-coated film or fiber; composites, such as an articulated bulk shape, film, or fiber). In some embodiments, moisture-indicating media particles or fibers may also be contained in a porous matrix. In some embodiments, the moisture-indicating medium may be adsorbed and/or impregnated on a solid (e.g., CoCl₂ supported on SiO₂) or dispersed or dissolved in a solvent.

In some embodiments, the moisture-indicating medium can be deposited on backing material or carrier material to create moisture-indicating cards and tapes according to conventional methods known in the art. Exemplary backing materials and carrier materials include those made of paper, kraft papers, polyethylene, polypropylene, polyester or composites of any of these materials. In some embodiments, the backing materials and carrier materials can be coated with release agents such as fluorochemicals or silicones. Exemplary tapes may comprise acrylic, urethane, and silicone polymers.

The moisture-indicating medium can be located in various positions within the sterilization environment. Exemplary locations include placing the moisture-indicating medium in the instrument tray within a wrapped instrument set (e.g., a vial containing the moisture-indicating medium placed in the tray), placing the moisture-indicating medium on the surface of the instrument tray (e.g., as a coating or tape), placing the moisture-indicating medium between the wrap and instrument tray within a wrapped instrument set (e.g., a vial placed between the wrap and tray, a tape placed on the outside of the tray between the tray and wrap, and a string carrying the indicator media at an end placed between the tray and wrap which can be removed after the sterilization cycle by pulling out from the wrap), placing the moisture-indicating medium within the wrap (e.g., between the fibers of the wrap, such as in a particle loaded web form), embedding or partially embedding the moisture-indicating medium in the fibers of the wrap (e.g., composite fiber, media particles adherent to surface of fibers), and making the moisture-indicating medium into the fibers of the wrap itself (e.g., polymeric indicator made into fibers that are used to make the wrap). In some embodiment, the moisture-indicating medium may be placed outside of the wrapped instrument set and in fluid communication with the inside of the wrapped instrument set (e.g., vial containing indicator media attached to a tube connected to the inside of the wrapped instrument set), or outside of the wrapped instrument set-inside a process challenge device which simulates the humidity exposure experienced inside of the wrapped instrument set (e.g., the moisture-indicating medium placed in a metal container and wrapped in a similar way as the wrapped instrument set). In any of the above locations, the color or visible spectrum of the moisture-indicating medium is, in some embodiment, visually observable (e.g., using wraps which provide sufficient transparency to allow determination of color differences in the dry and wet states of the moisture-indicating medium, using optical spectrum measurement tools to detect the visible spectrum of the moisture-indicating medium without opening and/or breaking the wrap of the wrapped instrument set, using wraps or containers that include a window through which the moisture-indicating medium is visible).

In some embodiments, the moisture-indicating medium or the wet pack indicators comprising a moisture-indicating layer comprising a moisture-indicating medium are designed to be placed on the exterior of an enclosure or package to be sterilized, such that the exterior of the enclosure or package is on the side of the moisture-indicating layer opposite the moisture-impermeable layer. While the wet pack indicator is placed on the exterior of an enclosure, it remains in fluid communication with the interior environment of the enclosure across a moisture-permeable portion of the exterior surface of the enclosure, and thus can provide an accurate visual indication of the moisture level within the internal environmental of the enclosure. In one embodiment, a wet pack indicator is placed on the exterior of a package that includes an enclosure defining a cavity wherein the enclosure allows permeation of steam into and out of the cavity.

The wet pack indicator can be located in various positions on the enclosure. Exemplary locations include placing one or more wet pack indicators on the exterior surface of the top, bottom, or sides of the wrapped sterilization package, or on the exterior surface of a sterilization filter. In any of the above locations, the moisture-indicating layer is in fluid communication with the environment of the interior cavity of the package. The color or visible spectrum of the moisture-indicating layer is, in some embodiments, visually observable (e.g., using moisture-impermeable layers that provide sufficient transparency to allow determination of color differences in the dry and wet states of the moisture-indicating layer, or constructing the wet pack indicator such that it can be removed from the package for observation from the side opposite the moisture-impermeable layer without compromising the internal package sterility).

In some embodiments, the moisture-indicating medium used in the method can comprise a solid support and a bis(glyoxime)-transition metal complex bound to the support. Compositions that include a solid support and a bis(glyoxime)-transition metal complex bound to the support can be used for colorimetric moisture or humidity determination. Depending upon composition, moisture-indicating media can be constructed which can quantitatively and reversibly determine the humidity level of the atmosphere to which the sensor is exposed.

It has been suggested that steam can significantly contribute to surface changes, particularly changes in the surface of metal oxides (e.g., hydroxyl groups), thereby resulting in adverse effects on such surfaces in the presence of steam. Applicants have surprisingly found that moisture-indicating media such as bis(glyoxime)-transition metal complexes bound to solid supports, particularly bound to solid metal oxide supports, can advantageously, accurately, and quantitatively detect the presence of moisture even after exposure to the steam sterilization environment.

In some embodiments, compositions are provided that include solid inorganic non-metal-oxide supports. Inorganic non-metal-oxide supports include inorganic solids having a polyatomic, oxygen-containing anion as identified in its crystal structure. In some embodiments, the inorganic non-metal-oxide supports are insoluble or only slightly soluble in water. In some embodiments, the inorganic non-metal-oxide supports have a solubility product (Ksp) value no greater than 1×10⁻³. Exemplary solid inorganic non-metal-oxide supports include phosphate, carbonate, sulfate, and hydroxide supports. In some embodiments, the non-metal-oxide inorganic support can include anhydrous calcium sulfate, zinc carbonate hydroxide, or calcium phosphate.

In some embodiments, the solid support can include organic polymeric supports. In general, hydrophilic polymers that have the ability to bind transition metal ions and their bis(glyoxime) complexes may be used. In some embodiments, ion exchange polymers having exchangeable ions bound to the polymer may be used. Herein, ion exchange generally refers to the exchange of ions attached to the polymer with the transition metal ions of the bis(glyoxime) transition metal complexes described herein. In some embodiments, solid organic polymeric supports may include polymers with functional groups capable of binding transition metal ions such as sulfonates, phosphates, and carboxylates. Suitable organic polymers may be natural or synthetic. Some exemplary organic polymeric supports include polyamides, polycarbonates, polyalkylene glycols, polyvinyl alcohols, polyvinyl ethers, alkyl cellulose, hydroxyalkyl celluloses, cellulose ethers, cellulose esters, nitro celluloses, methyl cellulose, ethyl cellulose, hydroxypropyl cellulose, hydroxy-propyl methyl cellulose, hydroxybutyl methyl cellulose, cellulose acetate, cellulose propionate, cellulose acetate butyrate, cellulose acetate phthalate, carboxylethyl cellulose, cellulose triacetate, and cellulose sulphate sodium salt.

In some embodiments, the solid organic polymeric support is a strong acid cation exchange resin. As used herein, the term “strong acid” refers to an acidic group that dissociates completely in water. Strong acids typically have a pKa less than 4 or 5. The strong acid cation exchange resins typically have ionic groups such as sulfonic acid groups (—SO3H), phosphonic acid groups (—PO3H2), or salts thereof. When present as a salt, the sulfonic acid groups are present as sulfonate anions and the phosphonic acid groups are present as phosphonate anions. Suitable salts often have cations selected from an alkali metal ion (e.g., sodium ion, lithium ion, or potassium ion), an alkaline earth metal ion (e.g., calcium or magnesium), an ammonium ion, or an ammonium ion substituted with one or more alkyl groups, aryl groups, or combinations thereof.

The cation exchange resins are typically crosslinked polymeric materials prepared from various ethylenically unsaturated monomers. The polymeric materials are usually based mainly on styrene, derivatives of styrene (e.g., alpha-methyl styrene), (meth)acrylates, or combinations thereof. The polymeric materials are typically crosslinked to provide the needed amount of rigidity. The cation exchange resins can be in the form of beads, films, fibers, or any other desired form.

In some embodiments, the cation exchange resins are polymeric materials prepared from styrene or derivatives of styrene. Divinyl benzene is commonly used as a crosslinker. The acidic groups can be introduced during the polymerization process by the inclusion of a monomer having an acidic group. Suitable monomers with an acidic group include, for example, 4-stryrene sulfonic acid, vinylsulfonic acid, or a salt thereof in the monomer mixture. Alternatively, the acidic group can be introduced after the polymerization process by treating the polymeric material with a sulfonating agent.

In other embodiments, the cation exchange resins are based on polymeric materials prepared from (meth)acrylate monomers. Monomers with multiple (meth)acryloyl groups can be used as a crosslinker. The acidic group can be introduced during the polymerization process by the inclusion of a monomer having a sulfonic acid group (e.g., N-acrylamidomethanesulfonic acid, 2-acrylamidoethanesulfonic acid, 2-acrylamido-2-methylpropanesulfonic acid, and 2-methacrylamido-2-methylpropanesulfonic acid, or a salt thereof) or by inclusion of a monomer having a phosphonic acid group (e.g., 2-acrylamidoethylphosphonic acid and 3-methacrylamidopropylphosphonic acid, or a salt thereof) Suitable (meth)acrylate-based strong cation exchange resins are further described in U.S. Pat. No. 7,098,253 (Rasmussen et al.), U.S. Pat. No. 7,683,100 (Rasmussen et al.), and U.S. Pat. No. 7,674,835 (Rasmussen et al.).

Strong acid cation exchange resins are commercially available from multiple suppliers. Examples include the cation exchange resins commercially available from Dow Chemical (Midland, Mich.) under the trade designation AMBERLYST (e.g., AMBERLYST 15, AMBERLYST 35, AMBERLYST 40, and AMBERLYST 70), under the trade designation DOWEX (e.g., DOWEX MARATHON and DOWEX MONOSPHERE), under the trade designation AMBERJET (e.g., AMBERJET 1000H), and under the trade designation AMBERLITE (e.g., AMBERLITE IR120H).

The strong acid cation exchange resin can be a gel-type resin or macroporous (i.e., macroreticular) resin. As used herein, the term “macroporous” refers to particles that have a permanent porous structure even in the dry state. Although the resins can swell when contacted with a solvent, swelling is not needed to allow access to the interior of the particles through the porous structure. In contrast, gel-type resins do not have a permanent porous structure in the dry state but must be swollen by a suitable solvent to allow access to the interior of the particles. In many embodiments, the strong acid cation exchange resins are macroporous. Macroporous resins tend to have a higher crosslinking density compared to gel-type resins.

The ion exchange capacity of the cation exchange resins if often at least 0.2 equivalents per liter, at least 0.5 equivalent per liter, at least 1 equivalents per liter, or at least 2 equivalents per liter. The capacity is often up to 10 equivalents per liter, up to 8 equivalents per liter, or up to 5 equivalents per liter. The capacity can be, for example, in a range of 0.1 to 10 equivalents per liter, in a range of 0.5 to 10 equivalents per liter, or in a range of 0.5 to 5 equivalents per liter. High capacity is often desired to adsorb more of the transition metal ion that is part of the bis(glyoxime)-transition metal complex onto the cation exchange resin.

In some embodiments, the solid support can include solid metal oxide supports. The solid metal oxide supports can be relatively colorless (e.g. clear, white, etc.) and capable of adsorbing or bonding to chromophoric species. In some embodiments, the provided solid metal oxide supports include oxides of silicon, aluminum, zirconium, titanium, or combinations thereof. Non-limiting examples of suitable metal oxides include silicon oxide, aluminum oxide, tin oxide, zinc oxide, titanium oxide, zirconium oxide, lanthanide (“rare-earth”) oxides, and mixtures thereof. Metal oxide supports can also include inorganic polymers (geopolymers) formed by reaction of a reactive solid aluminosilicate source such as a dehydroxylated clay with alkali silicate solution, such as those described in MacKenzie et al., Materials Letters, 63, 230-232 (2009). In some embodiments, the provided solid metal oxide supports can include alumina or silica gels, beads, or solid supports. Other exemplary metal oxide supports include zirconium oxide pellets and titanium (IV) oxide pellets. In some embodiments the solid metal oxide supports may comprise beads, pellets, spheres, granules, extrudates, tablets, nanoparticles, fibers, rods, needles, wovens, or non-wovens. In some embodiments, the metal oxide support may be in film form, such as coatings and free-standing films.

In some embodiments of the moisture-indicating medium, a bis(glyoxime)-transition metal complex is bound to the solid support. By bound it is meant that there is an attractive interaction between the bis(glyoxime)-transition metal complex and the solid support. The attractive interaction can include covalent bonds, ionic bonds, dative bonds, metallic bonds, hydrogen bonds, van der Waals forces, electrostatic forces, chemisorption, physisorption, or any other interaction that attracts the bis(glyoxime)-transition metal complex to the solid support. For example, when a bis(glyoxime)-transition metal complex that is insoluble in water or slightly soluble in water is bound to a solid support, it is typically not removed by successive or continuous rinsing with water. In some embodiments, the attractive interaction includes hydrogen bonds.

The bis(glyoxime)-transition metal complex includes two glyoxime moieties that form a complex with transition metals. The bis(glyoxime)-transition metal complex generally has the structure of Formula (I):

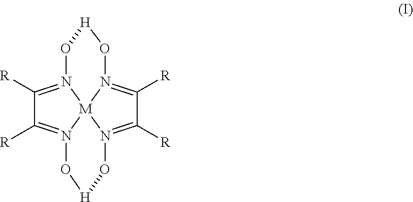

wherein:

M is a transition metal; and

R is independently selected from the groups comprising alkyl, such as ethyl and methyl; aryl, such as phenyl; thioaryl, such as thiophenyl; and a heterocyclic group, such as piperidine and morpholine.

Common glyoxime moieties include dialkylglyoximes such as, for example, dimethylglyoxime and diethylglyoxime. Common glyoximes that may also be useful in the provided compositions include diphenylglyoxime and bis(thiophenyl)glyoxime. Additionally, morpholine and piperidine have been reacted with anti-chloroglyoxime to give morpholineglyoxime and piperidineglyoxime. Since the transition metal ion complexes with the heteroatoms of the glyoxime species (nitrogen and oxygen, for example) it is contemplated that other substituents on the glyoxime molecule may be useful compositions if they do not interfere with the ability of the two glyoxime moieties to complex with a transition metal ion. When complexed, the bis(glyoxime)-transition metal complex typically has a square planar configuration. In some embodiments, the bis(glyoxime)-transition metal complex can include ions of rhodium, iridium, platinum, palladium, gold, nickel or copper which are well known by those of ordinary skill in the art to form square planar coordination complexes with glyoxime moieties like dimethylglyoxime. An exemplary bis(glyoxime)-transition metal complex for use in the moisture-indicating media is nickel dimethylglyoxime. A structure of an exemplary nickel bis(dimethylglyoxime) complex, bis-(dimethylglyoximato) nickel (II), is shown in Formula (II) below:

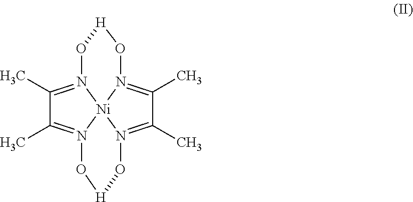

Using some of the above-identified compositions, colorimetric moisture-indicating media can be constructed. For example, when the solid metal oxide support is aluminum oxide, silicon oxide, or a combination thereof, and when the bis(glyoxime)-transition metal complex includes nickel and two dimethylglyoxime moieties (the complex shown in Formula (II)) a reversible colorimetric moisture-indicating media can be formed.

The color of the embodied moisture-indicating sensor can change quantitatively and reversibly according to the amount of moisture (e.g., liquid water, condensation, humidity, or relative humidity, etc.) in contact with the sensor. For example, a provided composition that includes bis(glyoxime)-transition metal complex (bis-(dimethylglyoximato)-nickel (II)) has a strong absorption at wavelengths from about 460 nm to about 570 nm with a peak at a wavelength of around 520 nm. The visible spectroscopic reflection intensity in the wavelength range of 460 nm to 560 nm and color, which is expressed to the Hue, of the composition changes quantitatively and reversibly according to the amount of moisture (e.g., liquid water, condensation, humidity, or relative humidity, etc.) in contact with the composition. By quantitatively it is meant that the reflection intensity in the wavelength range of 460 nm to 560 nm and the Hue, expressed by color, has a one-to-one correlation to the amount of humidity. By reversible it is meant that when the composition is exposed to one set of humidity conditions it has a specific absorption. When the set of humidity conditions is changed, the composition changes color to give a different specific reflection spectrum. And, when the composition is returned to the initial set of humidity conditions, the spectroscopic reflection spectrum (or color) returns to the original specific absorption. The visible absorbance peaks or reflection valleys of many other bis(glyoxime)-transition metal complexes having a square planar configuration are well known.

The amount of moisture to which the colorimetric moisture-sensor is exposed can be measured spectroscopically, for example, by reflection. Since the provided colorimetric moisture-indicating sensor is a solid, the change in color can be measured by reflecting light off of the surface of the solid and measuring the loss of intensity from wavelengths absorbed by the surface. In some embodiments, the absorbance at a given wavelength can be measured using an optics spectroscopy system that is configured for reflection spectroscopy. An exemplary optics spectroscopy system suitable for this measurement is Model Jaz-EL350, available from Ocean Optics, Dunedin, Fla. Typically, a spectrum from a white piece of paper or white powder can be used as a reference spectrum when measuring reflection intensity.

In some embodiments, the moisture-indicating medium can comprise a solid metal oxide support, a bis(glyoxime)-transition metal complex bound to the support, and a silyl-containing compound bound to the solid metal oxide support through a silanol bond with at least one hydroxyl group on the surface of the solid metal oxide support. In some embodiments, no more than about 50% of surface hydroxyl groups of the support are bound to the silyl-containing compound. The bis(glyoxime)-transition metal complex and the solid metal oxide support are described above.

Silyl-containing compounds having hydroxyl or hydrolyzable groups can react with surface hydroxyl groups of metal oxides and displace the hydroxyl or hydrolyzable groups on the silyl-containing compound to form a covalent —Si—O-M- bond (M is a metal or Si). Through this silanization, the surface of metal oxides can be covered by the silyl-containing groups. The properties of the modified metal oxide surfaces at least partially reflect the characteristics of the silyl-containing groups.

The silane modification of the solid metal oxide support can be accomplished in a variety of known ways. In some embodiments, the solid metal oxide support can be contacted with the silyl-containing compound to form a silane-modified solid metal oxide support. In some embodiments, no more than about 50% of surface hydroxyl groups of the metal oxide support are bound to the silyl-containing compound. In some embodiments, no more than 40%, 30%, 20%, or 10% of surface hydroxyl groups of the metal oxide support are bound to the silyl-containing compound.

In some embodiments, the solid metal oxide support is mixed into or contacted with a modification composition comprising a silyl-containing compound and an acid. The silyl-containing compound is generally present in the modification composition in amounts ranging from about 0.01% to about 10% (e.g., between 0.1% and 10%, between 0.5% and 5%, or between 1% and 3%) by weight, based on the total weight of the modification composition. The acid may be an organic or inorganic acid. Exemplary organic acids include acetic acid, citric acid, and formic acid. Exemplary inorganic acids include sulfuric acid, hydrochloric acid, and phosphoric acid. The acid will generally be included in the modification composition in an amount between about 0.005 and 10% (e.g., between 0.01 and 10% or between 0.05 and 5%) by weight, based on the total weight of the modification composition. In some embodiments, the modification composition additionally includes water. In some embodiments, the amount of water is between 0.1% and 99.9% (e.g., 0.5% to 95%, 0.5% to 90%, etc.) by weight based on the total weight of the modification composition.

In some embodiments, the solid metal oxide support is mixed into or contacted with a modification composition comprising a silyl-containing compound and a solvent. The silyl-containing compound is generally present in the modification composition in amounts ranging from about 0.1% to about 10% (e.g., between 0.05% and 5% or between 1% and 3%) by weight of the modification composition. Generally, the solvent is organic. Exemplary solvents include toluene, alcohols (e.g., ethanol, isopropanol, etc.), tetrahydrofuran, and hydrocarbon solvents (e.g., hexane, etc.). The solvent will generally be included in the modification composition in an amount between about 0.5% and 99.9% (e.g., between 1% and 99.5%, between 90% and 99%, etc.) by weight, based on the total weight of the modification composition.

In some embodiments, the solid metal oxide support and the silyl-containing compound may be reacted in an oven at elevated temperatures. Oven temperatures can range from 50° C. to 150° C. (e.g., 50° C. to 90° C., 100° C. to 130° C., 110° C. to 120° C., etc.). Oven reaction times can range from 10 hours to 20 hours (e.g., 12 hours to 18 hours or 14 hours to 16 hours). In some embodiments, the solid metal oxide support and the silyl-containing compound may be reacted through vapor deposition.

Various silyl-containing compounds can be used to modify the solid metal oxide support. In some embodiments, the silyl-containing compound is of Formula (III):

R¹—Si(R²)₃₋ₓ(R³)ₓ (III)

wherein R¹ is an alkyl, fluoroalkyl, alkyl substituted with an amino, aryl, aralkyl, or alkaryl group; each R² is independently hydroxyl or a hydrolyzable group; each R³ is independently a non-hydrolyzable group; and x is an integer equal to 0, 1, or 2. In some embodiments, the silyl-containing compound is of Formula (IV)

(R³)ₓ(R²)₃₋ₓSi—R⁴—Si(R²)₃₋ₓ(R³)ₓ (IV)

wherein R⁴ is an alkylene, arylene, or a combination thereof; each R² is independently hydroxyl or a hydrolyzable group; each R³ is independently a non-hydrolyzable group; and x is an integer equal to 0, 1, or 2.

In some embodiments, the hydrolyzable group can include alkoxy, aryloxy, acyloxy, halo, —N(R⁵)₂, or —NH—Si(R⁵)₃ where R⁵ is alkyl and the non-hydrolyzable group can include alkyl, aryl, aralkyl, or alkaryl. In some embodiments, the non-hydrolyzable group is alkyl, aryl, aralkyl, or alkaryl.

“Hydrolyzable group” refers to one of more groups bonded to a silicon atom in a silyl group that can react with water having a pH of 1 to 10 under conditions of atmospheric pressure. The hydrolyzable group is often converted to a hydroxyl group when it reacts. The hydroxyl group often undergoes further reactions such as reactions with hydroxyl groups on a surface of a metal oxide support. Exemplary hydrolyzable groups include, but are not limited to, alkoxy, acyloxy, halo, —N(R⁵)₂, or —NH—Si(R⁵)₃ where R⁵ is alkyl.

“Non-hydrolyzable group” refers to one of more groups bonded to a silicon atom in a silyl group that can react with water having a pH of 1 to 10 under conditions of atmospheric pressure. These groups typically do not undergo reactions such as reactions with hydroxyl groups on a surface of a metal oxide support. Exemplary non-hydrolyzable groups include, but are not limited to alkyl, aryl, aralkyl, and alkaryl.

“Alkyl” refers to a monovalent group that is a radical of an alkane. The alkyl group can have 1 to 40 carbon atoms. The alkyl group can be linear, branched, cyclic, or a combination thereof. When the alkyl is linear, it can have 1 to 40 carbon atoms, 1 to 30 carbon atoms, 1 to 20 carbon atoms, or 1 to 10 carbon atoms. When the alkyl is branched or cyclic, it can have 3 to 40 carbon atoms, 3 to 30 carbon atoms, 3 to 20 carbon atoms, or 3 to 10 carbon atoms.

“Alkylene” refers to a divalent group that is a radical of an alkane. The alkylene group can have 1 to 40 carbon atoms. The alkylene group can be linear, branched, cyclic, or a combination thereof. When the alkylene is linear, it can have 1 to 40 carbon atoms, 1 to 30 carbon atoms, 1 to 20 carbon atoms, or 1 to 10 carbon atoms. When the alkylene is branched or cyclic, it can have 3 to 40 carbon atoms, 3 to 30 carbon atoms, 3 to 20 carbon atoms, or 3 to 10 carbon atoms.

“Aryl” refers to a monovalent group that is a radical of an aromatic carbocyclic compound. The aryl group has at least one aromatic carbocyclic ring and can have 1 to 5 optional rings that are connected to or fused to the aromatic carbocyclic ring. The additional rings can be aromatic, aliphatic, or a combination thereof. The aryl group usually has 5 to 20 carbon atoms. In some embodiments, the aryl group is phenyl.

“Arylene” refers to a divalent group that is a radical of an aromatic carbocyclic compound. The arylene group has at least one aromatic carbocyclic ring and can have 1 to 5 optional rings that are connected to or fused to the aromatic carbocyclic ring. The additional rings can be aromatic, aliphatic, or a combination thereof. The aryl group usually has 5 to 20 carbon atoms. In some embodiments, the arylene is phenylene.

“Alkoxy” refers to a monovalent group of formula —OR where R is an alkyl as defined above. In some embodiments, the alkoxy is methoxy, ethoxy, or propoxy.

“Fluoroalkyl” refers to an alkyl having at least one hydrogen atom replaced with a fluoro.

“Aryloxy” refers to a monovalent group of formula —OAr where Ar is an aryl group.

“Acyloxy” refers to a monovalent group of formula —O(CO)—Ra where Ra is an alkyl, aryl, aralkyl, or alkaryl. In some embodiments, the acyloxy is —O(CO)CH₃ (acetoxy).

“Halo” refers to a monovalent group that is a radical of a halogen atom. The halo can be fluoro, chloro, bromo, or iodo. In some embodiments, the halo is chloro.

“Aralkyl” refers to an alkyl group substituted with at least one aryl group. The aralkyl group contains 6 to 40 carbon atoms. The aralkyl group often contains an alkyl group having 1 to 20 carbon atoms and an aryl group having 5 to 20 carbon atoms.

“Alkaryl” refers to an aryl group substituted with at least one alkyl group. The aralkyl group contains 6 to 40 carbon atoms. The aralkyl group often contains an aryl group having 5 to 20 carbon atoms and an alkyl group having 1 to 20 carbon atoms.

“Amino” refers to a monovalent group of formula —N(R⁶) where R⁶ is hydrogen or alkyl.

The specific silyl-containing compound can be chosen based on the desired relative humidity at which the final moisture indicating composition should undergo sharp color change. The characteristics of the silyl-containing compound (hydrophobic, hydrophilic, etc) generally correlate to the relative humidity at which the final moisture-indicating composition shows significant color change. One silyl-containing compound or mixtures of two or more silyl-containing compounds can be used to modify the solid metal oxide support and adjust the color response of the moisture-indicating compositions. In some embodiments, the silyl-containing compound may be hydrophobic. For example, hydrophobic compounds of Formula (III), include compounds where group R¹ plus any non-hydrolyzable group R³ are hydrophobic. As another example, hydrophobic compounds of Formula (IV), include compounds where group R⁴ plus any non-hydrolyzable group R³ are hydrophobic.

Exemplary silyl-containing compounds that may be bound to the solid metal oxide support include, but are not limited to, acetoxytrimethylsilane, t-butyldimethylchlorosilane, cyclohexylmethyldichlorosilane, cylcohexylmethyldimethoxysilane, 1,3-di-n-butyltetramethylsilazane, diethoxydimethylsilane, (diethylamino)trimethylsilane, (dimethylamino)trimethylsilane, diisopropyldichlorosilane, diisopropyldimethoxysilane, dimethyldichlorosilane, dimethyldiethoxysilane, dimethyldimethoxysilane, diphenyldichlorosilane, diphenyldiethoxysilane, diphenyldimethoxysilane, diphenylmethyldichlorosilane, dodecyltrichlorosilane, ethyltriacetoxysilane, ethyltrichlorosilane, ethyltrimethoxysilane, hexadecyltrimethoxysilane, hexanethyldisilazane, hexyltrimethoxysilane, isobutyltrimethoxysilane, isooctyltriethoxysilane, isooctyltrimethoxysilane, isobutyltriethoxysilane, methyltriacetoxysilane, methyltrichlorosilane, methyltriethoxysilane, methyltrimethoxysilane, n-octadecyldimethylchlorosilane, n-octadecyltrichlorosilane, n-octadecyltrimethoxysilane, n-octyltrichlorosilane, n-octyltriethoxysilane, n-octyltrimethoxysilane, phenethyltrimethoxysilane, phenyldimethylchlorosilane, phenylmethyldimethoxysilane, phenyltrichlorosilane, phenyldimethylchlorosilane, phenyltriethoxysilane, phenyltrimethoxysilane, n-propyltrichlorosilane, n-propyltriethoxysilane, n-propyltrimethoxysilane, trimethylchlorosilane, trimethylethoxysilane, trimethylmethoxysilane, 1H,1H,2H,2H-perfluoroctyldimethylchlorosilane, (3-aminopropyl)triethoxysilane, bis(triethyoxysilyl)ethane, and 1(triethoxysilyl)-2-(diethoxymethylsilyl)-ethane.

In some embodiments, the moisture-indicating medium can comprise cobalt and copper salts. In some embodiments, the salts will exhibit a visible color change when exposed to specific levels of moisture in the surrounding environment. The salts may alternately exhibit measurable changes in opacity, Hue, or reflection spectrum at when exposed to specific levels of moisture in the surrounding environment. Exemplary salts that can be used as the moisture-indicating medium in the methods, articles, and packages described herein include CoCl₂, CoBr₂, Co(SCN)₂, CuCl₂, CuBr₂, and combinations thereof. In one exemplary embodiment, the moisture-indicating medium comprises CoCl₂.

In some embodiments, the moisture-indicating medium can comprise pH-indicator dyes. Without wishing to be bound by theory, it is believed that pH-indicator dyes operate as moisture indicators because water from the surrounding environment (e.g., liquid water, condensation, water vapor, humidity, or relative humidity, etc.) can dilute the pH indicator compositions, causing the pH of these compositions to approach neutrality. As pH-indicator compositions dry, the environment around the pH indicator becomes acidic or basic, based on the particular composition, thus causing the pH-indicator dye in the composition to change color to indicate the change in pH. For example, phenolphthalein-based pH-indicator compositions may turn from pink to colorless as the pH-indicating composition dries from neutral (dilution) to basic state (dry), thus reflecting the level of moisture in the environment surrounding the pH-indicator composition. pH indicator dyes known in the art are useful as the moisture-indicating medium in the methods, articles, and packages described herein. Some exemplary pH-indicating dyes useful as the moisture-indicating medium in the methods, articles, and packages described herein include litmus, cyandin, neutral red, alizarin, alkali blue, thymolphthalein, phenolphthalein, crystal violet, chlorophenol red, cresol red, thymol blue, m-cresol purple, and p-xylenol blue.

Following are exemplary embodiments of methods of detecting moisture and packages used therein according to aspects of the present invention.

Embodiment 1 is a method of detecting moisture comprising sequential steps:
(a) subjecting an article comprising a reversible moisture-indicating medium to steam sterilization in a steam sterilizer to produce a sterilized article;
(b) subjecting the sterilized article to drying to reduce moisture in the sterilized article;
(c) removing the sterilized article from the steam sterilizer; and
(d) determining the level of moisture in the sterilized article after step (c) based on at least one property of the moisture-indicating medium.

Embodiment 2 is a method according to embodiment 1, wherein the at least one property of the reversible moisture-indicating medium is selected from the group comprising color and opacity.

Embodiment 3 is a method according to any one of the preceding embodiments, wherein the at least one property of the moisture-indicating medium is directly related to the current level of moisture in the environment within which the moisture-indicating medium is located.

Embodiment 4 is a method according to any one of the preceding embodiments, wherein determining the level of moisture in the sterilized article comprises visually observing the moisture-indicating medium.

Embodiment 5 is a method according to any one of the preceding embodiments, wherein determining the level of moisture in the sterilized article comprises observing the color of the moisture-indicating medium.

Embodiment 6 is a method according to embodiment 5, wherein the color of the moisture-indicating medium is directly related to the current level of moisture in the environment within which the moisture-indicating medium is located.

Embodiment 7 is a method according to embodiment 5, wherein observing the color of the moisture indicating medium comprises determining the Hue of the color of the moisture indicating medium.

Embodiment 8 is a method according to embodiment 7, wherein the Hue is quantitatively related to the current level of moisture in the environment within which the moisture-indicating medium is located.

Embodiment 9 is a method of any one of the preceding embodiments further comprising the step of:
(e) comparing the at least one property of the reversible moisture-indicating medium to a corresponding predetermined threshold to determine whether the sterilized article is adequately dry.

Embodiment 10 is method according to any one of the preceding embodiments, wherein determining the level of moisture comprises visually observing the color of the reversible moisture-indicating medium.

Embodiment 11 in a method according to any one of embodiments 1-9, wherein determining the current level of moisture comprises measuring the visible reflection or transmission spectra of the moisture indicating medium.

Embodiment 12 is a method according to any one of the preceding embodiments, wherein the article further comprises a cavity defined by an enclosure.

Embodiment 13 is a method according to embodiment 12 further comprising placing the reversible moisture-indicating medium in fluid communication with the cavity prior to step (a).

Embodiment 14 is a method according to any one of the preceding embodiments further comprising placing the article into a steam sterilizer prior to step (a).

Embodiment 15 is a method of any one of the preceding embodiments, wherein the article further comprises a post-steam sterilization wet pack indicator comprising:
a moisture-impermeable layer having a first surface; and
a moisture-indicating layer comprising the moisture-indicating medium;
   wherein the moisture-indicating layer is disposed on or near the first surface of the moisture-impermeable layer or the moisture-impermeable layer comprises a recess and the moisture-indicating layer is disposed within the recess; and wherein the moisture-indicating layer is dimensionally smaller than the moisture-impermeable layer, and the edges of the moisture-impermeable layer extend beyond the edges of the moisture-indicating layer.

Embodiment 16 is a method according to any one of embodiments 12 or 13, wherein the reversible moisture-indicating medium is disposed within the cavity.

Embodiment 17 is a method according to embodiment 15, wherein at least a portion of the enclosure comprises a moisture-permeable material; the moisture-permeable material has an interior defining a portion of the cavity; the and moisture-permeable material has an exterior; and the post-steam sterilization wet pack indicator is located on the exterior of the moisture-permeable material.

Embodiment 18 is a method according to embodiment 17 wherein the moisture-impermeable layer of the post-steam sterilization wet pack indicator is peripherally bonded to the exterior of the moisture-permeable material such that the moisture indicating layer is disposed between the moisture-permeable portion of the enclosure and the moisture-impermeable layer.

Embodiment 19 is a method according to any one of the preceding embodiments, wherein the article comprises at least one of a rigid container, a flexible container, a non-woven wrap, a peel pouch, a polymeric matrix, paper, and combinations thereof.

Embodiment 20 is a method according to any one of the preceding embodiments, wherein the reversible moisture-indicating medium comprises a solid support and a bis(glyoxime)-transition metal complex bound to the solid support.

Embodiment 21 is a method according to embodiment 20, wherein the solid support comprises an inorganic support or an organic polymeric support.

Embodiment 22 is a method according to embodiment 21, wherein the solid support comprises an organic polymeric support and the organic polymeric support is a strong acid cation exchange resin.

Embodiment 23 is a method according to embodiment 21, wherein the solid support is an inorganic support and the inorganic support is a solid metal oxide support.

Embodiment 24 is a method according to embodiment 23, wherein the reversible moisture-indicating medium further comprises a silyl-containing compound bound to the solid metal oxide support through a silanol bond with at least one hydroxyl group on the surface of the solid metal oxide support.

Embodiment 25 is a method according to embodiment 24, wherein the silyl-containing compound is hydrophobic.

Embodiment 26 is a method according to any of embodiments 24 or 25, wherein the silyl-containing compound is of Formula (III)

R¹—Si(R²)₃₋ₓ(R³)ₓ (III)

wherein

R¹ is an alkyl, fluoroalkyl, alkyl substituted with an amino group, aryl, aralkyl, or alkaryl;

each R² is independently hydroxyl or a hydrolyzable group;

each R³ is independently a non-hydrolyzable group; and

x is an integer equal to 0, 1, or 2.

Embodiment 27 is a method according to any one of embodiments 24 or 25, wherein the silyl-containing compound is of Formula (IV)

(R³)ₓ(R²)₃₋ₓSi—R⁴—Si(R²)₃₋ₓ(R³)ₓ (IV)

wherein

R⁴ is an alkylene, arylene, or a combination thereof;

each R² is independently hydroxyl or a hydrolyzable group;

each R³ is independently a non-hydrolyzable group; and

x is an integer equal to 0, 1, or 2.

Embodiment 28 is a method according to any one of embodiments 26 or 27, wherein the hydrolyzable group is alkoxy, aryloxy, acyloxy, halo, —N(R⁵)₂, or —NH—Si(R⁵)₃ where R⁵ is alkyl.

Embodiment 29 is a method according to any one of embodiments 26-28, wherein the non-hydrolyzable group is alkyl, aryl, aralkyl, or alkaryl.

Embodiment 30 is a method according to any one of embodiments 24-29, wherein the silyl-containing compound is selected from the group consisting of diethoxydimethylsilane, hexanethyldisilazane, n-octadecyltrichlorosilane, 1H 1H 2H 2H perfluoroctyldimethylchlorosilane, and (3-aminopropyl)triethoxysilane.

Embodiment 31 is a method according to any one of embodiments 24-30, wherein no more than about 50% of surface hydroxyl groups of the support are bound to the silyl-containing compound.

Embodiment 32 is a method according to any one of embodiments 20-31, wherein the bis(glyoxime)-transition metal complex comprises nickel dimethylglyoxime.

Embodiment 33 is a method according to any one of embodiments 1-15, wherein the reversible moisture-indicating medium comprises at least one of CoCl₂, CoBr₂, Co(SCN)₂, CuCl₂, CuBr₂, and combinations thereof.

Embodiment 34 is a method according to embodiment 33, wherein the reversible moisture-indicating medium comprises CoCl₂.

Embodiment 35 is a method according to any one of embodiments 1-19, wherein the reversible moisture-indicating medium comprises a pH indicator dye.

Embodiment 36 is a method according to embodiment 35, wherein the reversible moisture-indicating medium comprises phenolphthalein.

Embodiment 37 is a method according to any of the preceding embodiments, wherein the moisture-indicating medium quantitatively changes reflection or transmission spectra at relative humidities ranging from about 0% to about 90% relative humidity.

Embodiment 38 is a method according to any of the preceding embodiments, wherein the moisture-indicating medium quantitatively changes reflection or transmission spectra at relative humidities ranging from about 30% to about 80% relative humidity.

Embodiment 39 is a method according to any of the preceding embodiments, wherein the moisture-indicating medium is placed on a backing material.

Embodiment 40 is a method according to embodiment 39, wherein the backing material comprises at least one of paper, acrylic polymers, urethane polymers and silicone polymers.

Embodiment 41 is a package comprising:
an enclosure defining a cavity; and
a reversible steam-sterilization-compatible moisture-indicating medium in fluid communication with the cavity; and
   wherein at least a portion of the enclosure comprises a moisture-permeable material and allows permeation of steam into and out of the cavity.

Embodiment 42 is a package according to embodiment 41, wherein the enclosure comprises at least one of a rigid container, a flexible container, a non-woven wrap, a woven wrap, a peel pouch, a polymeric matrix, paper, and combinations thereof.

Embodiment 43 is a package according to any one of embodiments 41-42, wherein at least a portion of the package further comprises at least one of paper, sponges, wovens, non-wovens, and combinations thereof.

Embodiment 44 is a package according to any one of embodiments 41-43, wherein the cavity is in fluid communication with the interior space of a sterilization package.

Embodiment 45 is a package according to any one of embodiments 41-44, wherein the package further comprises a post-steam sterilization wet pack indicator disposed upon the moisture-permeable material;

wherein the post-steam sterilization wet pack indicator comprises:
a moisture-impermeable layer; and
a moisture-indicating layer comprising the moisture-indicating medium;
   wherein the moisture-impermeable layer of the wet pack indicator is peripherally bonded to the moisture-permeable material such that the moisture-indicating layer is disposed between the moisture-permeable material and the moisture-impermeable layer.

Embodiment 46 is a package according to embodiment 45, wherein the moisture-permeable material has an interior defining a portion of the cavity; the and moisture-permeable material has an exterior; and

wherein the wet pack indicator is peripherally bonded to the exterior of the moisture-permeable material.

Embodiment 47 is a package according to any one of embodiments 41-46, wherein the reversible steam-sterilization-compatible moisture-indicating medium comprises a solid support and a bis(glyoxime)-transition metal complex bound to the solid support.

Embodiment 48 is a package according to embodiment 47, wherein the solid support comprises an inorganic support or an organic polymeric support.

Embodiment 49 is a package according to embodiment 48, wherein the solid support comprises an organic polymeric support and the organic polymeric support is a strong acid cation exchange resin.

Embodiment 50 is a package according to embodiment 48, wherein the solid support is an inorganic support and the inorganic support is a solid metal oxide support.

Embodiment 51 is a package according to embodiment 44, wherein the reversible steam-sterilization-compatible moisture-indicating medium further comprises a silyl-containing compound bound to the solid metal oxide support through a silanol bond with at least one hydroxyl group on the surface of the solid metal oxide support.

Embodiment 52 is a package according to embodiment 51, wherein the silyl-containing compound is hydrophobic.

Embodiment 53 is a package according to any one of embodiments 51-52, wherein the silyl-containing compound is of Formula (III)

R¹—Si(R²)₃₋ₓ(R³)ₓ (III)

wherein

R¹ is an alkyl, fluoroalkyl, alkyl substituted with an amino group, aryl, aralkyl, or alkaryl;

each R² is independently hydroxyl or a hydrolyzable group;

each R³ is independently a non-hydrolyzable group; and

x is an integer equal to 0, 1, or 2.

Embodiment 54 is a package according to any one of embodiments 51-52, wherein the silyl-containing compound is of Formula (IV)

(R³)ₓ(R²)₃₋ₓSi—R⁴—Si(R²)₃₋ₓ(R³)ₓ (IV)

wherein

R⁴ is an alkylene, arylene, or a combination thereof;

each R² is independently hydroxyl or a hydrolyzable group;

each R³ is independently a non-hydrolyzable group; and

x is an integer equal to 0, 1, or 2.

Embodiment 55 is a package according to any one of embodiments 53-54, wherein the hydrolyzable group is alkoxy, aryloxy, acyloxy, halo, —N(R⁵)₂, or —NH—Si(R⁵)₃ where R⁵ is alkyl.

Embodiment 56 is a package according to any one of embodiments 53-55, wherein the non-hydrolyzable group is alkyl, aryl, aralkyl, or alkaryl.

Embodiment 57 is a package according to any one of embodiments 51-56, wherein the silyl-containing compound is selected from the group consisting of diethoxydimethylsilane, hexanethyldisilazane, n-octadecyltrichlorosilane, 1H 1H 2H 2H perfluoroctyldimethylchlorosilane, and (3-aminopropyl)triethoxysilane.

Embodiment 58 is a package according to any one of embodiments 51-57, wherein no more than about 50% of surface hydroxyl groups of the support are bound to the silyl-containing compound.

Embodiment 59 is a package according to any one of embodiments 47-58, wherein the bis(glyoxime)-transition metal complex comprises nickel dimethylglyoxime.

Embodiment 60 is a package according to any one of embodiments 41-46, wherein the reversible steam-sterilization-compatible moisture-indicating medium comprises at least one of CoCl₂, CoBr₂, Co(SCN)₂, CuCl₂, CuBr₂, and combinations thereof.

Embodiment 61 is a package according to embodiment 60, wherein the reversible steam-sterilization-compatible moisture-indicating medium comprises cobalt chloride.

Embodiment 62 is a package according to any one of embodiments 41-46, wherein the reversible moisture-indicating medium comprises a pH indicator dye.

Embodiment 63 is a package according to embodiment 62, wherein the reversible moisture-indicating medium comprises phenolphthalein.

Embodiment 64 is a package according to any one of embodiments 41-63, wherein the package is a sterilization package.

Embodiment 65 is a package according to any one of embodiments 41-64, wherein the package further comprises at least one object to be sterilized.

Embodiment 66 is a package according to any one of embodiments 41-65, wherein the package further comprises at least one object selected from the group consisting of surgical instruments, medical devices, dental instruments, implants, dressings, and bandages

Embodiment 67 is a package according to any one of embodiments 41-66, wherein the package further comprises surgical instruments.

Embodiment 68 is a package according to any one of embodiments 41-63, wherein the package is a process challenge device.

Embodiment 69 is a package according to embodiment 68, wherein the package further comprises challenge layers.

Embodiment 70 is a package according to embodiment 69, wherein the challenge layers surround the moisture-indicating medium.

Embodiment 71 is a package according to any one of embodiments 69-70, wherein the challenge layers are all constructed of the same material.

Embodiment 72 is a package according to any one of embodiments 69-70, wherein the challenge layers are each independently constructed of different materials.

Embodiment 73 is a package according to any one of embodiments 69-72, wherein the challenge layers are constructed of at least one of hydrophilic or hydrophobic sponges, papers, wovens, and non-wovens.

Embodiment 74 is a package according to any one of embodiments 41-73, further comprising a window for viewing the cavity, the moisture-indicating medium, or combinations thereof.

Embodiment 75 is a package according to any one of embodiments 41-74, wherein the moisture-indicating medium quantitatively changes reflection or transmission spectra at relative humidities ranging from about 0% to about 90% relative humidity.

Embodiment 76 is a package according to any one of embodiments 41-75, wherein the moisture-indicating medium quantitatively changes reflection or transmission spectra at relative humidities ranging from about 30% to about 80% relative humidity.

Embodiment 77 is a package according to any one of embodiments 41-76, wherein the moisture-indicating medium is placed on a backing material.

Embodiment 78 is a package according to embodiment 77, wherein the backing material comprises at least one of paper, acrylic polymers, urethane polymers and silicone polymers.

### EXAMPLES

Objects and advantages of this invention are further illustrated by the following examples, but the particular materials and amounts thereof recited in these examples, as well as other conditions and details, should not be construed to unduly limit this invention.

### Optoelectronic Measurement

The color changes of moisture indicators were observed using a spectroscopy system. One end of a reflection optical probe (Model QR400-7-UV-VIS, obtained from Ocean Optics of Dunedin, Floirda) was connected to a light source (Model HL-2000-FHSA, available from Ocean Optics) and the other to a spectrometer (Jaz-EL350, available from Ocean Optics). The probe was located next to vials containing moisture indicators. A spectrum from vials containing white Al₂O₃ spheres (Sasol Germany GmbH, Tonerdekugel, −1,8-210, 1.78 mm, 207 m²/g) was taken for a reference spectrum for reflection intensity. The wavelength range of spectra was from 340.6 nm to 1031.1 nm. The obtained reflection spectrum was expressed to color (Hue) as following. The measured reflection spectrum was constructed to International Commission on Illumination (or “CIE”) XYZ color space using color matching the CIE 1931 2° Standard Observer function. The CIE XYZ color space was linear transformed to National Television System Committee (NTSC) RGB space using NTSC color space chromaticity coordinates (x_{R}=0.67, y_{R}=0.33. x_{G}=0.21, y_{G}=0.71, x_{B}=0.14, y_{B}=0.08). Then, Hue which is one of the main properties of a color, was computed from RGB values. Hue is defined as the degree to which a stimulus can be described as similar to or different from stimuli that are described as red, green, and blue. The color can be correlated to a location (Hue) in the color wheel from 0 degree to 360 degree. The color at 0 degree is equal to that at 360 degree. When color changes from 10 degree to 350 degree, 350 degree was displayed as −10 degree (=350-360) for showing continuous color change. All mathematical process was done by a customized LABVIEW program (software available from National Instruments of Austin, Tex.). The conversion from spectra to Hue was confirmed by measuring spectra from color printed papers with known Hue, calculating Hue from spectra and comparing Hue from spectra with the known Hue of color printed papers. Hues from spectra were consistent with the known Hues of color printed papers.

### Steam Sterilization Process

The sterilization processes conditions for several of the following examples are described hereafter. Any exceptions to these conditions are specified in the individual Example descriptions. Moisture indicating materials were transferred to vials (Cat No. 66011-020, phenolic cap on, short form style, obtained from VWR of Radnor, Pa.). In order to observe the color change of indicators before and after sterilization, indicators were sterilized using commercially available steam sterilizers. The vials containing moisture indicating materials were located inside the main chamber of the sterilizer with caps halfway open. Three different sterilization processes at three different temperatures were used: 121° C., 132° C., and 135° C. A steam sterilizer (Model 410 AC1 obtained from Getinge of Rochester, N.Y.) was employed to sterilize indicators at 121° C. and 135° C. For the 121° C. sterilization process, the exposure time of steam at 121° C. was 10 minutes based on gravity sterilization process. The post vacuum depth was 1 bar. The drying cycle time was 1 minute. For 135° C. sterilization process, three cycles of vacuum—pulses were used before sterilization. The exposure time of steam at 135° C. was 3 minutes. The post vacuum depth was 0.062 bar. The drying cycle time was 1 minute. Another steam sterilizer (Model AMSCO 3013C obtained from Steris of Mentor, Ohio) was employed to sterilize indicators at 132° C. For 132° C. sterilization process, four cycles of vacuum—pulses were used before sterilization. The exposure time of steam at 132° C. was 4 minutes. The drying time was 1 minute and the drying vacuum was 10 inches Hg.

### Example 1

### PREPARATION OF Ni²⁺/dimethylglyoxime/Al₂O₃ beads

To 20.01 grams of Al₂O₃ spheres (Sasol Germany GmbH, Tonerdekugel, −1,8-210, 1.78 mm, 207 m²/g) was added 40.37 grams of 5 wt % aqueous solution of nickel acetate tetrahydrate (EM Science, Gibbstown, N.J.) and the mixture was swirled for 12 minutes to allow adsorption of the nickel onto the surface of the alumina substrate. The mixture was then vacuum-filtered over Whatman #5 filter paper and washed with deionized water to remove any residual free nickel ions in the liquid layers coating the particles. The light-green colored beads were then dried on a glass Petri dish in air at 110° C. for 15 minutes with intermittent mixing. The partially dried, light-green beads were then cooled slightly before adding directly to 40.06 grams of basic dimethylglyoxime solution (0.12 grams dimethylglyoxime (Mallinckrodt Chemical Works, New York, N.Y.) and 1.55 grams 1M aqueous solution of potassium hydroxide (BDH Chemicals, West Chester, Pa.) in 28.39 grams deionized water). The beads changed color from light-green to bright pink within seconds after mixing. The mixture was swirled for 2 minutes to give bright pink beads and a slight pink colored solution. The solids were vacuum-filtered over Whatman #5 filter paper and washed with deionized water to remove residual nickel glyoxime precipitate from the beads. The free nickel glyoxime often forms a film on the surface of the solution above the beads during filtering. This film is readily skimmed off the surface to minimize the incorporation of non-color changing material (solid nickel glyoxime) onto the beads. The washed, filtered solids were then transferred to a glass Petri dish and dried in an oven at 110° C. overnight in air for approximately 2 hours. The dried material was brown-yellow in color, and weighed 20.05 grams

Ni²⁺/dimethylglyoxime/Al₂O₃ beads described above were exposed to three different sterilization processes (121° C., 132° C., and 135° C.). The post steam sterilization drying cycle time was 1 minute. TABLE 1 summarizes the visual color and appearance of the moisture indicating media before sterilization, after sterilization (and drying cycle), and after sterilization followed by immersion in water. Most of Ni²⁺/dimethylglyoxime/Al₂O₃ beads were green after sterilization. However, since the drying cycles (1 minute) were shorter than typical commercial use drying cycles (of 20 minutes), a small amount of pinkish color persisted in some beads, especially in the case of 132° C. and 135° C. sterilized samples. After immersing beads into water, all beads turned to pink. The color results in TABLE 1 show that the colorimetric, moisture indicating functionality of the Ni²⁺/dimethylglyoxime/Al₂O₃ beads was maintained through the sterilization processes.

TABLE 1
EXAMPLE 1 Results: Color Change of Prepared
Ni²⁺/dimethylglyoxime/Al₂O₃ beads

| | | After Steam | After Steam |
|---|---|---|---|
| Steam | | Sterilization | Sterilization |
| Sterilization | Before Steam | (including | and After Immer- |
| Temperature | Sterilization | drying cycle) | sion in Water |
| 121° C. process | Yellow-Green | Green (95%) | Pink |
| | | and partially | |
| | | pinkish beads | |
| 132° C. process | Yellow-Green | Green (70%) | Pink |
| | | and partially | |
| | | pinkish beads | |
| 135°° C. process | Yellow-Green | Green (90%) | Pink |
| | | and partially | |
| | | pinkish beads | |

### Example 2

Commercially available cobalt chloride based silica dessicant (Cat No. DX0017-1, t.h.e Desiccant, obtained from EMD of Rockland, Mass.) was exposed to three different steam sterilization processes (121° C., 132° C., and 135° C.), as described in EXAMPLE 1. The drying cycle time of sterilization was 1 minute. TABLE 2 shows the color response of indicators before sterilization, after sterilization, and after sterilization and then immersion in water. Most of beads turned to blue-purple color after sterilization. After immersing beads into water, all beads turned to purple.

TABLE 2
EXAMPLE 2 Results: Color Change of CoCl₂/SiO₂ beads

| | | After Steam | After Steam |
|---|---|---|---|
| Steam | | Sterilization | Sterilization |
| Sterilization | Before Steam | (including | and After Immer- |
| Temperature | Sterilization | drying cycle) | sion in Water |
| 121° C. process | Dark blue | Mixture of | Purple |
| | | light blue | |
| | | and dark blue | |
| 132° C. process | Dark blue | Mixture of | Purple |
| | | light blue | |
| | | and dark blue | |
| 135° C. process | Dark blue | Mixture of | Purple |
| | | light blue | |
| | | and dark blue | |

### Example 3

In order to correlate the amount of water condensation showing noticeable color change of indicators, the following systematic experiment was performed. Ni²⁺/dimethylglyoxime/Al₂O₃ beads were exposed to 135° C. steam sterilization process with 20 minutes drying time. As described in Example 2, all beads after sterilization were green. An amount of 0.50 grams of Ni²⁺/dimethylglyoxime/Al₂O₃ beads was transferred to each vial. Various quantities of water were injected to each vial. After water injection, the beads were mixed well by hand shaking the vials. The vials were tightly capped and heated in an oven at 120° C. for 10 minutes to redistribute the water homogenously on the surfaces of the indicator media. For comparison, the nominal loss of water from the vial under these conditions was accessed by adding 500 μl of water into a vial without beads. The vial was tightly capped then heated in an oven at 120° C. for 10 minutes. The weight loss after heating was 0.0170 grams, which corresponds to only a 3.4% loss of water.

TABLE 3 shows the Reflection Intensity (%) data of the exemplary Ni²⁺/dimethylglyoxime/Al₂O₃ beads without water, with 40 μL and 200 μL of water. In order to obtain similar brightness, all reflection spectra were normalized by setting the maximum reflection intensity observed at 850 nm to 100%. Example 3 demonstrated that greatest change in Reflection Intensity (%) across the visible spectrum of light, was observed in the sample treated with the most amount of water.

TABLE 3
EXAMPLE 3 Results - Reflection Intensity (%)

| Wavelength (nm) | No water | 40 μL water | 200 μL water |
|---|---|---|---|
| 400.12 | 79.55 | 60.78 | 58.48 |
| 450.29 | 84.52 | 73.11 | 72.38 |
| 500.14 | 92.19 | 73.40 | 62.56 |
| 550.00 | 97.62 | 72.74 | 53.30 |
| 600.15 | 97.49 | 92.39 | 91.15 |

TABLE 4, below, shows the Hue of Example 3 as a function of the water amount added to 0.5 grams of Ni²⁺/dimethylglyoxime/Al₂O₃ beads. The Hue of the sample without water is around 80 (corresponding to yellow-green color) while the sample with 200 μL of water added is approximately 0 (corresponding to red-pink color). A quantity of 100 μL of water added to 0.5 grams of Ni²⁺/dimethylglyoxime/Al₂O₃ beads corresponds to 20 weight percentage of water (weight of water/weight of beads) and yields similar red pink color.

TABLE 4
EXAMPLE 3 Hue of Ni²⁺/dimethylglyoxime/
Al₂O₃ beads expose to various amounts of water

| Water Volume (μL) | |
|---|---|
| in 0.5 grams Ni²⁺/ | |
| dimethylglyoxime/Al₂O₃ beads | Hue |
| 0 | 80 |
| 20 | 84 |
| 40 | 33 |
| 60 | 38 |
| 80 | 26 |
| 100 | 16 |
| 120 | 14 |
| 140 | 9 |
| 160 | 9 |
| 180 | 4 |
| 200 | −1 |

### Example 4

Quantitative measurement of the reversible color changing property of the indicator during the steam sterilization process was obtained by simulating similar steam sterilization conditions using a customized heating block, a heating bar, a thermocouple, and a feedback loop temperature controller (Model AEO 000-149, obtained from Custom Heat LLC of Danvers, Mass.). The heating block was made of aluminum and the heating bar was imbedded inside the heating block. The temperature of the heating block was monitored by the thermocouple and the current through the heating bar was controlled by the feedback-loop temperature control to maintain the intended temperature. The glass vial was inserted in the heating block and the color change of the indicator material was observed through a window. The operating temperature of the heating block was 121° C.

An amount of 0.50 grams of Ni²⁺/dimethylglyoxime/Al₂O₃ beads was added to a vial (Cat No. 66011-020, with phenolic cap on, short form style, obtained from VWR of Radnor, Pa.). The heating block was preheated to 121° C. and kept at this temperature for the duration of the experiment. To raise the temperature of indicator material to 121° C., the vial containing the indicator material was left for 10 minutes after inserting the uncapped vial into the heating block. Next, an injection of 300 μL of water was made into the vial to simulate exposure to moisture conditions as in a steam sterilization process. The color was continuously monitored throughout the drying process using the Ocean Optics spectrometer. As shown in TABLE 5, the Ni²⁺/dimethylglyoxime/Al₂O₃ beads show a distinct color (Hue) change 12 minutes after the injection of water (simulating moisture content in steam), and then again after all the water was evaporated off the indicator material 36-40 minutes after the water injection. Based on this experiment, it took approximately 25-30 minutes to evaporate 300 μL of water off the 0.5 grams of indicator material. This Example demonstrates the reversible color change property of the Ni²⁺-dmg/Al₂O₃ indicator material at an elevated temperature, representing a simulated steam sterilization (and drying) process.

TABLE 5
EXAMPLE 4 Hue of Ni²⁺/dimethylglyoxime/Al₂O₃ beads
at 121° C., over time, after exposure to water

| Time (minutes) | Hue |
|---|---|
| 0 | 64 |
| 4 | 66 |
| 8 | 65 |
| 10 | 65 |
| 12 | 17 |
| 16 | 15 |
| 20 | 17 |
| 24 | 16 |
| 28 | 13 |
| 32 | 19 |
| 36 | 37 |
| 40 | 70 |
| 50 | 76 |
| 60 | 75 |
| 70 | 75 |

### Example 5

Wet load and dry load conditions of steam sterilization processes were intentionally generated using two different drying time and post vacuum depth conditions with the steam sterilizer (Model 410 AC1 obtained from Getinge of Rochester, N.Y.) to investigate the correlation between the color response of the indicators and moisture condensation surrounding the indicators. For both wet and dry load conditions, three cycles of pressure/vacuum pulses before sterilization and 3 minutes of the steam exposure time at 135° C. were used. In wet load conditions, the post vacuum depth was 1 bar and the drying time was 1 second. In dry load conditions, the post vacuum depth was 0.328 bar and the drying time was 35 minutes. Two different types of sterilizer containers (A and B) were employed. Container A was an aluminum perforated surgical instrument autoclave basket with lid (3.8 kilograms, with approximate dimensions: 60 cm×28 cm×13 cm, obtained from Aesculap Inc. USA of Center Valley, Pa.). Container A was wrapped with disposable sterilization wrap (140 cm of KC-600 KIMGUARD, available from Kimberly Clark of Dallas, Tex.). Container B was a rigid aluminum sterilization container with a non-woven filter (3/4 size DBP STERILCONTAINER with 1 tray; bottom model #5N740; perforated bottom with retention plate and model #JK789 lid, with approximate dimensions: 43 cm×28 cm×11 cm, available from Aesculap Inc. USA), which by design did not require additional sterilization wrap for microbial barrier. Both instrument trays, Container A and Container B contained surgical instruments (an assortment of 24 instruments: stainless steel surgical scissors and forceps). Uncapped vials containing approximately 0.3 g of Ni²⁺/dimethylglyoxime/Al₂O₃ beads were located inside Container A (the wrapped instrument tray), inside Container B (the unwrapped rigid instrument tray with filter), and outside Containers A and B, yet inside the sterilization chamber. TABLE 6 shows visual observations and color response of indicators in wet and dry load conditions. The color response of indicators was consistent with visual observation of liquid water in the various locations of the sterilization environment. The indicator inside Container A under dry load conditions was mostly (70%) green color, indicating dry conditions. In this same sample, there were a few beads that showed a partial pink coloration due to the presence of liquid water in a physically separate location within the wrapped environment, though the water was not in direct contact with the vial or beads. The results of Example 5 in TABLE 6 show that this embodiment of the Wet Pack moisture indicator can distinguish between actual wet pack (unacceptable) and properly dried (acceptable) post steam sterilization conditions.

TABLE 6
EXAMPLE 5 Results - Wet Load and Dry
Load Steam Sterilization Conditions

| | | | | Outside |
|---|---|---|---|---|
| | Type of | Inside | Inside | Containers |
| Condition | Result | Container A | Container B | A &B |
| Wet load | Visual | Pooled water | Pooled water | Water |
| condition | observation | observed | observed | droplets |
| | | | | observed |
| | Color of | Pink | Pink | Pink |
| | indicator | | | |
| Dry load | Visual | Water | Dry surfaces | Dry surfaces |
| condition | observation | droplets | | |
| | | observed | | |
| | | between tray | | |
| | | and wrap | | |
| | Color of | Green (70%) | Yellow- | Yellow- |
| | indicator | and partially | Green | Green |
| | | pinkish | | |
| | | beads | | |

### Example 6

A test pack was employed to simulate the moisture conditions inside sterilizer containers. The test pack construction used for the evaluation was a 3M ATTEST 41382/41382F Rapid 5 Steam-Plus Test Pack (available from 3M Company of St. Paul, Minn.). This product has a central die-cut cavity in the geometric center of the pack, into which sterilization process indicators are placed. The moisture indicators were located in these test packs. Moisture indicating materials were placed in semi-transparent plastic containers with plastic caps. The containers and caps were obtained by using the 3M ATTEST 1292 Rapid Readout Biological Indicator vial, which comes with the ATTEST 41382/41382F Test Pack. The vials were emptied of their internal contents (the cylindrical vial dimensions were approximately 5.1 cm long by 0.8 cm diameter; the cap dimensions were 1.6 cm long by 1 cm diameter. The piece of filter paper covering the six vent holes of the cap were maintained. The plastic containers containing Ni²⁺/dimethylglyoxime/Al₂O₃ beads (ca. 0.3 g) were located inside the central cavity of the test packs and some test packs (with moisture indicators inside) were then also placed inside Container A and wrapped as in Example 5, while the other test packs were placed outside Container A, yet inside the sterilization chamber. The test packs and wrapped Container A were exposed to the same sterilization process conditions as described in Example 5, at 135° C., except that the post-vacuum depth was 0.0625 bar and the drying time was 45 minutes in dry load conditions described below. TABLE 7 shows color response of Example 6 sample indicators inside test packs and inside test packs wrapped in Container A for wet and dry load conditions. These results demonstrate that the Wet Pack moisture indicator, when placed inside a test pack construction described above, can distinguish between actual wet pack (unacceptable) and properly dried (acceptable) post steam sterilization conditions.

TABLE 7
EXAMPLE 6 Results: Wet Load and Dry
Load Conditions utilizing Test Packs

| Wet load condition | | Dry load condition | |
|---|---|---|---|
| Inside 3M | Inside Test | Inside 3M | Inside Test |
| ATTEST | Pack in wrapped | ATTEST | Pack in wrapped |
| Test Pack | Container A | Test Pack | Container A |
| Pink (80%) and | Pink | Yellow-Green | Yellow-Green |
| partially greenish | | | |
| beads | | | |

### Example 7

### Example 7a

### Preparaton of Ni²⁺/dimethylglyoxime/HMDS-modified Al₂O₃ beads

Sasol 1.8 mm alumina beads (3.1438 g, Sasol Germany GmbH, Tonerdekugel, −1,8-210, 1.78 mm, 207 m²/g) were added to a small 23 mL volume polytetrafluoroethylene (PTFE) autoclave liner cup, and a smaller 1 mL alumina cup was then placed on top of the beads in the PTFE liner cup. To the smaller alumina cup was added 0.3820 grams of hexamethyldisilazane (HMDS) (Alfa Aesar, Ward Hill, Mass.). The PTFE lid was secured on the PTFE liner cup and the entire assembly was carefully placed into a stainless steel autoclave reactor vessel (4749 General Purpose Bomb, 23 mL 250° C., 1800 psig, Parr Instruments Co., Moline, Ill.). After securing/tightening the autoclave reactor, the entire autoclave assembly was placed into an oven held at 110° C. for ˜64 hours. The reactor vessel was then cooled by placing it in an alumina pan filled with water up to a level equal to half the height of the autoclave reactor vessel. The vessel was cooled for several hours prior to opening. The cooled beads weighed 3.5761 grams.

To a 40 mL glass vial, 2.4921 g of HMDS-modified Al₂O₃ beads (as prepared above) was immersed into 5.0454 grams of 5 wt % aqueous solution of nickel acetate tetrahydrate (EM Science, Gibbstown, N.J.) for ˜12 minutes. Initial addition of the beads resulted in the beads floating on the surface of the solution. Additional mixing by swirling was required to allow the beads to settle. The beads were then thoroughly washed by water wash/decant cycles to remove most of the residual nickel solution. The beads were then vacuum filtered over a #5 Whatman filter paper and washed a final time before drying on a glass Petri dish at 110° C. for 5 minutes. The free-rolling beads were then cooled in a small aluminum pan for at least 10 minutes prior to the next step. The cooled, green beads were quickly added to 4.99 grams of basic dimethylglyoxime solution (Formulation: 0.12 grams dimethylglyoxime (Mallinckrodt Chemical Works, New York, N.Y.) and 11.54 grams 1M aqueous solution of potassium hydroxide (BDH Chemicals, West Chester, Pa.) in 28.34 grams deionized water) and the mixture was continually mixed for 120 seconds before thoroughly washing the beads by water wash/decant cycles to remove residual pink/red solids and solution from the surface of the beads. Only a small amount of residue and pink coloration in solution was observed. The beads were then vacuum filtered over a #5 Whatman filter paper and any remaining residuals were skimmed off the surface of the filtering solution above the beads. Little to no pink coloration was observed on the filter paper after filtration. The washed beads were then dried at 110° C. in air for 30 minutes to give uniformly dark yellow colored beads.

### Example 7b

### Preparaton of Ni²⁺/dimethylglyoxime/DEDMS-modified Al₂O₃ beads

In a small glass jar, 1.0120 grams of diethoxydimethylsilane (DEDMS) (Alfa Aesar, Ward Hill, Mass.) was added to 50.0372 grams of diluted acetic acid (aq) solution (pH ˜5.5-6; ˜0.01 mM) to initially form an emulsion. After approximately 2 minutes of vortex mixing and swirling, and brief degassing using a sonicator, a clear, colorless solution was obtained. To this solution was added 5.0306 grams of Al₂O₃ beads (Sasol Germany GmbH, Tonerdekugel, −1,8-210, 1.78 mm, 207 m²/g). The mixture was mixed by hand for 5 minutes before washing the beads and decanting at least three times to remove residual solution form the surface of the beads. The beads were then vacuum filtered over a #5 Whatman filter paper and dried on a glass Petri dish in an oven at 110° C. for 10 minutes.

To a 40 mL glass vial, 2.5040 grams of DEDMS-modified Al₂O₃ beads (as prepared above) was immersed into 5.0335 grams of 5 wt % aqueous solution of nickel acetate tetrahydrate (EM Science, Gibbstown, N.J.) for ˜12 minutes. No floating beads were observed. The beads were then thoroughly washed by water wash/decant cycles to remove most of the residual nickel solution. The beads were then vacuum filtered over a #5 Whatman filter paper and washed a final time before drying on a glass Petri dish at 110° C. for 5 minutes. The free-rolling beads were then cooled in a small aluminum pan for at least 10 minutes prior to the next step. The beads were quickly added to 5.00 grams of basic dimethylglyoxime solution (Formulation: 0.12 grams dimethylglyoxime (Mallinckrodt Chemical Works, New York, N.Y.) and 11.54 grams 1M aqueous solution of potassium hydroxide (BDH Chemicals, West Chester, Pa.) in 28.34 grams deionized water) and the mixture was continually mixed for 120 seconds before thoroughly washing the beads by water wash/decant cycles to remove residual pink/red solids and solution from the surface of the beads. Only a small amount of residue and pink coloration in solution was observed. The beads were then vacuum filtered over a #5 Whatman filter paper and any remaining residuals were skimmed off the surface of the filtering solution above the beads. Little to no pink coloration was observed on the filter paper after filtration. The washed beads were then dried at 110° C. in air for 30 minutes. to give uniformly light yellow colored beads.

### Example 7c

### Preparaton of Ni²⁺/dimethylglyoxime/DEDMS-modified SiO₂ microbeads

Diethoxydimethylsilane (DEDMS) (0.53 g, Alfa Aesar, Ward Hill, Mass.) was added to 25.07 grams of ˜0.01 M acetic acid (aq) solution (pH ˜6) to initially form an emulsion (˜2.07 wt % DEDMS). After approximately 3 minutes of vortex mixing and swirling, a clear, colorless solution was obtained. To this solution was added 2.52 grams Silica Gel 60 (150-230 mesh, Alfa Aesar, Ward Hill, Mass.). After mixing by hand for 5 minutes, the beads were subjected to three deionized water wash/decant cycles to remove residual solution form the surface of the beads. The beads were then vacuum filtered over a #5 Whatman filter paper and further washed on the filter several times before drying on a glass Petri dish in an oven at 110° C. for 10 minutes.

The dried beads were then cooled to room temperature before adding 5.08 grams of 5 wt % aqueous solution of nickel acetate tetrahydrate (EM Science, Gibbstown, N.J.) and continuing immersion for 10 minutes. The beads were then water washed/decanted three times to remove excessive solution on the surface of the beads prior to vacuum filtration over a #5 Whatman filter paper with further water washing. The wet beads were transferred to a large glass jar into which 10.15 grams of basic dimethylglyoxime solution (Formulation: 0.12 grams dimethylglyoxime (Mallinckrodt Chemical Works, New York, N.Y.) and 11.56 grams 1M aqueous solution of potassium hydroxide (BDH Chemicals, West Chester, Pa.) in 28.32 grams deionized water) was quickly added. The mixture was allowed to mix for 60 seconds before thorough wash/decant cycles to remove most of the residuals and pink colored solution. The wet beads were then transferred to a glass Petri dish and dried for 2 hours at 110° C. in air to give light yellow, uniform colored beads.

### Example 7d

### Preparaton of Ni²⁺/dimethylglyoxime/OTS-modified SiO₂ microbeads

1.9983 grams of SiO₂ gel 60 (Alfa Aesar, 150-230 mesh, 500-600 m²/g, Lot 108W033) were immersed in 4 ml of 1% (v/v) n-octadecyltrichlorosiliane (OTS) (Alfa Aeaser Lot 10136042) solution in toluene. The mixture was gently shaken for 5 minutes and the beads were rinsed with toluene three times and then deionized water more than five times. The beads were filtered using #1 Whatman filter paper and dried in an oven at 110° C. for 30 minutes.

An amount of 5.09 grams of 5 wt % aqueous solution of nickel acetate tetrahydrate (EM Science, Gibbstown, N.J.) was added to 1.51 grams of OTS-modified silica gel (as prepared above). The beads were allowed to immerse for 10 minutes at room temperature after initial hand mixing. The beads were then water washed/decanted three times to remove excessive solution on the surface of the beads prior to direct, rapid addition of 5.30 grams of basic dimethylglyoxime solution (Formulation: 0.12 grams dimethylglyoxime (Mallinckrodt Chemical Works, New York, N.Y.) and 11.56 grams 1M aqueous solution of potassium hydroxide (BDH Chemicals, West Chester, Pa.) in 28.32 grams deionized water). The mixture was allowed to mix for 60 seconds before thorough wash/decant cycles to remove most of the residuals and pink colored solution, followed by vacuum filtration over a #5 Whatman filter paper and skimming of the surface to remove floating residues. The wet, pink beads were then transferred to a glass Petri dish and dried for 1 hour at 110° C. in air to give light yellow, uniform colored beads.

### Example 8

### Example 8a

### pH Indicator Based Moisture Indicator on Glass

Commercially available spackling material DRYDEX (manufactured by DAP Products Inc. of Baltimore Md.) contains a color changing pH indicator (phenolphthalein). DRYDEX approaches neutrality from weak basicity when spackling materials with pH indicator dries and pH indicator changes color from pink (basic) to colorless (neutral). The spackling material DRYDEX with pH indicator based moisture indicator material was applied to a glass slide (precleaned microslide, Cat #48300-025, VWR). The color of Example 8a changed from pink when initially applied (wet) to white upon drying since the spackling material without indicator was white.

### Example 8b

### pH Indicator Based Moisture Indicator on Polymer Film

The spackling material DRYDEX with pH indicator based moisture indicator was applied to a polymeric film (Teonex Q51/200 Polyethylene Naphthalate (PEN), obtained from DuPont Teijin Films, Hopewell, Va.). The color of Example 8b changed from pink to white upon drying.

### Example 8c

### pH Indicator Based Moisture Indicator on Paper

The spackling material DRYDEX with pH indicator based moisture indicator was applied to #1 Whatman filter paper, obtained from Whatman Ltd, Maidstone, England). The color of Example 8c changed from pink to white upon drying.

Examples 7a-7d and 8a-8c were exposed to a 135° C. steam sterilization process using the steam sterilizer described in Example 5. Moisture indicating materials were transferred to vials. The vials containing moisture indicating materials were located inside the main chamber of the sterilizer without caps. For 135° C. sterilization process, three cycles of vacuum-pulses were used before sterilization. The exposure time of steam at 135° C. was 3 minutes. The post vacuum depth was 0.062 bar. The drying cycle time was 20 minutes. TABLE 8 summarizes the test results for Examples 7a-7d and 8a-8c. The visual color appearance of the moisture indicating media before sterilization, after sterilization (and drying cycle), and after sterilization followed by immersion in water. After immersing indicators into water, all indicators turned to pink which reflected wet-state indicator color.

TABLE 8
EXAMPLES 7 and 8

| | | After Steam | After Steam |
|---|---|---|---|
| | | Sterilization | Sterilization |
| | Before Steam | (including | and After |
| Example | Sterilization | drying cycle) | Immersion in Water |
| Example 7a | Yellow-Green | Green | Pink |
| Example 7b | Yellow-Green | Green | Pink |
| Example 7c | Yellow-Green | Orange-Yellow | Pink |
| Example 7d | Yellow-Green | Orange-Yellow | Pink |
| Example 8a | White | White | Pink |
| Example 8b | White | White | Pink |
| Example 8c | White | White | Pink |

### Example 9

### Preparation of Colorimetric Moisture-Indicatin Media: Ni²⁺/dimethylgloxime/Al₂O₃

To 40.15 grams of 5 wt % aqueous solution of nickel acetate tetrahydrate (EM Science, Gibbstown, N.J.) was added 20.10 grams of BioRad AG® 7 neutral alumina microbeads, 100-200 mesh (Berkeley, Calif.). The mixture was jar rolled for 12 minutes before decanting and washing three times with deionized water. The mixture was then vacuum-filtered over a #5 WHATMAN filter paper in a Buchner funnel and further washed with deionized water. The collected solids were dried in air at 110° C. for 15 minutes. The hot beads were quickly transferred (within 20 seconds of removal from the oven) directly into a basic dimethylglyoxime aqueous solution (formulation: 0.12 grams dimethylglyoxime (Mallinckrodt Chemical Works, New York, N.Y.), 11.58 grams 1 M aqueous solution of potassium hydroxide (BDH Chemicals, West Chester, Pa.), 28.37 grams deionized water). The beads rapidly changed to a bright pink color, along with the formation of residual red/pink colored material and pink solution. After two minutes of mixing, the mixture was decanted and washed with deionized water at three times to remove most of the residuals. The mixture was then vacuum-filtered over a #5 WHATMAN filter paper in a Buchner funnel, and further washed with deionized water. The collected solids were dried in air at 110° C. for 70 minutes. The dried solids were pale yellow in color.

### Construction of Wet Pack Indicator

The wet pack indicator (WPI) was prepared in the following manner. A piece of transparent polypropylene film tape (SCOTCH 3750 Commercial Performance Packaging Tape, available from 3M Company of St. Paul, Minn., USA) was cut to a 1 centimeter square size and then manually coated with particles of the colorimetric moisture-indicating media prepared above. The tape was completely covered so that an approximate monolayer of particles was adhered to the pressure sensitive adhesive (PSA) side of the one centimeter square piece of tape. This coated piece of tape was then centered and placed on a second larger square piece of the same type of tape, such that the PSA side of the second piece of tape contacted the polypropylene backing of the first piece of tape. The second square piece of tape was approximately 2.5 centimeters on each side, 6.25 square centimeters in total area. This created a “PSA border” with a width of about 0.75 centimeters around the first piece of tape coated with colorimetric moisture-indicating media. A release liner was obtained by taking the release liner from a sheet of AVERY White Full-Sheet Shipping Labels for Laser Printers 5165, available from Avery Dennison of Pasadena, Calif., USA, and cutting it to size, 2.5 cm×2.5 cm square to fit the second square piece of tape. The release liner was placed over the exposed PSA of the second piece of tape and also covered the colorimetric moisture-indicating media of the first piece of tape. The SCOTCH 3750 Commercial Performance Packaging Tape was selected for its high temperature durability. The tape was also selected because the adhesive was robust enough to withstand the humidity, temperature and pressure conditions in the steam sterilizer without significant delamination. The release liner is removed prior to placing the WPI onto the outer surface of the sterilization package wrap or filter surface, described below.

The construction of the WPI as described ensures that the film covering the media is less steam/water vapor permeable than the sterilization fabric upon which it is intended to be placed. This construction required the steam/water vapor to reach the media under the carrier tape by first passing through the wrap fabric and into the inner cavity of the package and then passing back through the wrap fabric under the location of the colorimetric moisture-indicating media. In this way the level of humidity which the media was indicating was related to the humidity level within the packaging inner cavity.

### Steam Sterilization Conditions

A steam sterilizer (GETINGE Model 410 AC1 obtained from Getinge USA, Inc. of Rochester, N.Y.) was employed to test the WPI under simulated Dry Load and induced Wet Load conditions at 135° C. Three cycles of vacuum pulses were used before sterilization. The exposure time to steam at 135° C. was 3 minutes. For the Dry Load, the post vacuum depth was 32.8 kPa (0.328 bar), and the drying time was 40 minutes. For the Wet Load the post vacuum depth was 90 kPa (0.9 bar) and the drying time was 1 second.

TABLE 9A
Programmed Process Conditions for Steam Sterilization
Equipment: Getinge 410 AC1
Cycle: 135° C./275° F. 3-min Pre-vacuum (dynamic air removal)

| | |
|---|---|
| PREVACUUM PULSES | 3 |
| PULS 1 + LVL | 2.200 BAR (220 kPa) |
| PULS 2 + LVL | 2.200 BAR |
| PULS 3 + LVL | 2.200 BAR |
| PULS 1 − LVL | 0.333 BAR (33.3 kPa) |
| PULS 2 − LVL | 0.667 BAR (66.7 kPa) |
| PULS 3 − LVL | 0.667 BAR |
| VAC HOLD TM | 0:00:00 |
| (h:mm:ss) | |
| EVAC RAMP REG | 0.710/M |
| STEAM PRESS REG | 0.710/M |
| STERILIZE REG | 85.0/M |
| EXPOSURE TEMP | 135.0° C. |
| EXPOSURE TIME | 0:03:00 |
| (h:mm:ss) | |
| EXPOSURE F0 | 10 |

TABLE 9B
Final Cycles: Dry Load vs. Wet Load Process Conditions

| Process Condition | DRY CYCLE | WET CYCLE |
|---|---|---|
| POST VACUUM DEPTH | 32.8 kPa (0.328 BAR) | 90 kPa (0.9 BAR) |
| DRYING TIMER | 0:40:00 | 0:00:01 |
| (h:mm:ss) | | |

### Sterilization Containers

Two types of sterilization packaged containers were used in these experiments. Container A was a 3M M306 AUTOCLAVE CASE, a perforated hinged lid stainless steel case with handles and internal tray dimensions of 36.4×22.2×9.4 centimeters (14.25×8.75×3.75 inches), available from 3M Company of St. Paul, Minn., USA. Container A was filled with stainless steel medical instruments, and was completely wrapped with a blue non-woven sterilization wrap, KIMGUARD ONE STEP STERILIZATION WRAP KC400, available from Kimberly-Clark of Irving, Tex. Each sheet of the KC400 wrap is actually two sheets of SMS fabric bonded together on the edges. Container B was a V. Mueller Genesis Sterilization Container with dimensions 28×58×15 centimeters (11×23×6 inches), made of anodized aluminum. Container B also had 4 flat, built-in filter compartments, 2 each on the top and on the bottom of the container. One sheet of the KC400 wrap was pulled apart into two separate sheets of SMS material. This single SMS sheet was cut to size and used as the filter material for the 4 filter compartments of Container B.

### Use of the WPI

For each WPI, the liner was removed and the WPI was applied to the target location, making certain that the adhesive border was well sealed around the edges of the indicator media. The WPI was adhered to the outer surface of the KC400 sterilization wrap on Container A and on the outer facing surface of the SMS filter material used for Container B. The WPIs were placed in the following specific locations. Two WPIs were placed on the bottom, and one on the side of the wrapped Container A. One WPI was placed on each of the 4 filters placed into the 4 built-in filter compartments of Container B, two each on the top and the bottom of Container B. Container A was placed on the top shelf of the two shelf autoclave chamber, and Container B was placed on the bottom shelf. The two packages were placed into the steam sterilizer and exposed to the steam sterilization treatment conditions described above for Dry Load. Two additional, identical packages were prepared in the same manner and subjected to the Wet Load process conditions. The packages were removed from the sterilizer and the color of each of the WPIs was visually examined to determine the level of moisture remaining in the package after the sterilization treatment.

### Example 9

### Results

For all results, a visual observation of the color of the WPI was made before and after the exposure to the Dry Load or Wet Load steam sterilization process cycles. The term “pale” was used to indicate a visual perception of a relatively lighter or less saturated version of the color observed. For example, the result “pale yellow” would be considered a relatively lighter version of yellow; or a less saturated yellow. Likewise, “pale pink” would be considered a relatively lighter version of pink; or a less saturated pink. The color pink itself is generally regarded as a lighter version of the color red; or a less saturated red, since, for example, the mixing of red paint and white paint results in a paint of the color pink. Before being exposed to any moisture, each dry WPI appeared pale yellow in color. When saturated with water, the WPI turned pink in color.

TABLE 10
Dry Load Container A

| | Side | Bottom | Bottom |
|---|---|---|---|
| Condition | site #1 | site #1 | site #2 |
| Before Sterilization | Pale yellow | Pale yellow | Pale yellow |
| After Sterilization | Pale yellow | Pale pink | Pink |

After exposure to Dry Load sterilization conditions, Container A appeared to have liquid water remaining between the bottom of the metal container and the inner wrap surface, leading to the pink coloration of the WPI placed at the bottom of the packaging. However, the WPI at the side of the package indicated a dry package. Therefore, correct placement of the WPI is important depending on the indication level desired. Given the process conditions used, apparently even 40 minutes of drying time was not enough to evaporate all moisture from inside wrap (container). The WPI successfully indicated the moisture environments inside the wrap even though the WPI were attached to the outside of the wrap.

TABLE 11
Dry Load Container B

| | Top | Top | Bottom | Bottom |
|---|---|---|---|---|
| Condition | site #1 | site #2 | site #1 | site #2 |
| Before | Pale yellow | Pale yellow | Pale yellow | Pale yellow |
| Sterilization | | | | |
| After | Pale yellow | Pale yellow | Pale yellow | Pale yellow |
| Sterilization | | | | |

After exposing Container B to Dry Load sterilization conditions, the exterior and the interior of the container including the filter appeared completely dry. Each WPI also appeared pale yellow after sterilization, indicating a dry package. Prior to exposure to the steam sterilization conditions the prepared WPI all appeared pale yellow in color. As a verification of the indicator's ability to sense moisture, after exposure to the steam sterilization conditions, one WPI was intentionally spiked with a small amount of water and immediately turned from pale yellow to an intense pink color.

TABLE 12
Wet Load Wrapped Container A

| | Side | Bottom | Bottom |
|---|---|---|---|
| Condition | site #1 | site #1 | site #2 |
| Before Sterilization | Pale yellow | Pale yellow | Pale yellow |
| After Sterilization | Pale orange | Pale Pink | Pink |

After exposing Container A to Wet Load sterilization conditions, the wrap on the bottom side of the container had severe moisture condensation even though no moisture condensation was observed on the side of the container. The color of the WPIs changed from pale yellow (which was before sterilization) to pale orange for the side site, and to pale pink and pink for the two bottom sites, indicating an increasing amount of moisture detected at different locations around Container A.

TABLE 13
Wet Load Container B

| | Top | Top | Bottom | Bottom |
|---|---|---|---|---|
| Condition | site #1 | site #2 | site #1 | site #2 |
| Before | Pale yellow | Pale yellow | Pale yellow | Pale yellow |
| Sterilization | | | | |
| After | Pink | Pink | Pink | Pink |
| Sterilization | | | | |

After exposing Container B to Wet Load sterilization conditions, the container was opened and pooled water was observed inside at the bottom of Container B. The pink color of the WPIs accurately indicated this wet condition.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows. All references cited in this disclosure are herein incorporated by reference in their entirety.

1. A method of detecting moisture comprising sequential steps:
(a) subjecting an article comprising a reversible moisture-indicating medium to steam sterilization in a steam sterilizer to produce a sterilized article;
(b) subjecting the sterilized article to drying to reduce moisture in the sterilized article;
(c) removing the sterilized article from the steam sterilizer; and
(d) determining the level of moisture in the sterilized article after step (c) based on at least one property of the moisture-indicating medium.

2. The method of claim 1, wherein the article further comprises a cavity defined by an enclosure.

3. The method of claim 2 further comprising placing the reversible moisture-indicating medium in fluid communication with the cavity prior to step (a).

4. The method of claim 1, wherein the article further comprises a post-steam sterilization wet pack indicator comprising:
a moisture-impermeable layer having a first surface; and
a moisture-indicating layer comprising the moisture-indicating medium;
wherein the moisture-indicating layer is disposed on or near the first surface of the moisture-impermeable layer or the moisture-impermeable layer comprises a recess and the moisture-indicating layer is disposed within the recess; and
wherein the moisture-indicating layer is dimensionally smaller than the moisture-impermeable layer, and the edges of the moisture-impermeable layer extend beyond the edges of the moisture-indicating layer.

5. The method of claim 2, wherein the reversible moisture-indicating medium is disposed within the cavity.

6. The method of claim 4, wherein at least a portion of the enclosure comprises a moisture-permeable material; the moisture-permeable material has an interior defining a portion of the cavity; the and moisture-permeable material has an exterior; and the post-steam sterilization wet pack indicator is located on the exterior of the moisture-permeable material.

7. The method of claim 6 wherein the moisture-impermeable layer of the post-steam sterilization wet pack indicator is peripherally bonded to the exterior of the moisture-permeable material such that the moisture indicating layer is disposed between the moisture-permeable portion of the enclosure and the moisture-impermeable layer.

8. The method of claim 1, wherein the article comprises at least one of a rigid container, a flexible container, a non-woven wrap, a peel pouch, a polymeric matrix, paper, and combinations thereof.

9. The method of claim 1, wherein the reversible moisture-indicating medium comprises a solid support and a bis(glyoxime)-transition metal complex bound to the solid support.

10. The method of claim 9, wherein the solid support comprises a strong acid cation exchange resin.

11. The method of claim 9, wherein the solid support comprises a solid metal oxide support.

12. The method of claim 11, wherein the reversible moisture-indicating medium further comprises a silyl-containing compound bound to the solid metal oxide support through a silanol bond with at least one hydroxyl group on the surface of the solid metal oxide support.

13-16. (canceled)

17. A package comprising:
an enclosure defining a cavity; and
a reversible steam-sterilization-compatible moisture-indicating medium in fluid communication with the cavity; and
wherein at least a portion of the enclosure comprises a moisture-permeable material and allows permeation of steam into and out of the cavity.

18. The package of claim 17, wherein the enclosure comprises at least one of a rigid container, a flexible container, a non-woven wrap, a woven wrap, a peel pouch, a polymeric matrix, paper, and combinations thereof.

19. The package of claim 17, wherein at least a portion of the package further comprises at least one of paper, sponges, wovens, non-wovens, and combinations thereof.

20. The package of claim 17, wherein the cavity is in fluid communication with the interior space of a sterilization package.

21. The package of claim 17, wherein the package further comprises a post-steam sterilization wet pack indicator disposed upon the moisture-permeable material;
wherein the post-steam sterilization wet pack indicator comprises:
a moisture-impermeable layer; and
a moisture-indicating layer comprising the moisture-indicating medium;
wherein the moisture-impermeable layer of the wet pack indicator is peripherally bonded to the moisture-permeable material such that the moisture-indicating layer is disposed between the moisture-permeable material and the moisture-impermeable layer.

22. The package of claim 21, wherein the moisture-permeable material has an interior defining a portion of the cavity; the moisture-permeable material has an exterior; and
wherein the wet pack indicator is peripherally bonded to the exterior of the moisture-permeable material.

23. The package of claim 17, wherein the reversible steam-sterilization-compatible moisture-indicating medium comprises a solid support and a bis(glyoxime)-transition metal complex bound to the solid support.

24. The package of claim 23, wherein the solid support comprises a strong acid cation exchange resin.

25. The package of claim 23, wherein the solid support comprises a solid metal oxide support.

26-31. (canceled)
